(19) United States
(12) Patent Application Publication
(10) Pub. No.: US 2026/0301256 A1
(43) Pub. Date: Oct. 1, 2026

(54) SYSTEM FOR GENERATING PRESENTATION DOCUMENTS FROM USER-GENERATED DOCUMENTS USING A GENERATIVE SERVICE

(71) Applicant: Atlassian Pty Ltd., Sydney (AU)

(72) Inventors: Ahmad Alqadhy, San Diego, CA (US); Nicholas Wang, Breckenridge, CO (US)

(21) Appl. No.: 19/091,760

(22) Filed: Mar. 26, 2025

(51) Int. Cl. G06T 11/60; G06F 40/30; G06F 40/40

(52) U.S. Cl. CPC G06T 11/60; G06F 40/30; G06F 40/40; G06T 2200/24

(57) ABSTRACT

A computer-implemented method of generating a presentation from a user-generated document may include receiving an instruction to generate a presentation from the user-generated document, extracting user-generated content from the user-generated document, and generating a set of candidate presentation segments using a generative output system. A presentation document including the candidate presentation segments may be generated, displayed, and stored.

### TECHNICAL FIELD

The present disclosure is generally directed to presentation documents, and more particularly, to systems and methods for automatically generating presentation documents from user-generated content.

### BACKGROUND

Modern electronic devices facilitate a myriad of uses, both for business and personal endeavors. For example, electronic devices like personal computers, tablets, mobile phones, are used in both business and personal contexts for creating and storing documents, writing computer code, communicating with other individuals (e.g., via email, chat services, voice and video calls, etc.), and the like. Increasingly, electronic devices are used to develop and display presentation documents.

### SUMMARY

A computer-implemented method of generating a presentation from a user-generated document may include causing display of a graphical user interface of a client application operating on a client device, the graphical user interface including a content pane configured to display a user-generated document in a non-paginated view mode providing continuous scrolling of the user-generated document, and a content tree displayed in a content tree pane. The content tree may include a tree of selectable elements corresponding to a set of documents having a hierarchical relationship to the user-generated document. The method may include receiving, from the graphical user interface, an instruction to generate a presentation from the user-generated document, the instruction including an identifier of the user-generated document and a natural language input, extracting user-generated content from the user-generated document, analyzing the natural language input to determine a user intent parameter for the presentation, and generating a set of candidate presentation segments. The generating may include generating a presentation generation prompt including predetermined query prompt text, the extracted user-generated content from the user-generated document, and the user intent parameter for the presentation. The method may further include providing the presentation generation prompt to a generative output engine and receiving a generative response from the generative output engine. The method may further include, based on the generative response, generating a set of candidate presentation segments, causing the set of candidate presentation segments to be displayed in a presentation preview window of the graphical user interface, receiving, in the presentation preview window, a first user input modifying a candidate presentation segment of the set of candidate presentation segments, thereby producing a modified set of candidate presentation segments, in response to a second user input accepting the modified set of candidate presentation segments, generating a presentation document including the modified set of candidate presentation segments, storing the presentation document in association with a document platform and displaying an identifier of the presentation document in position in the content tree reflecting a hierarchical relationship between the presentation document and the user-generated document, and causing display of content of the presentation document in the graphical user interface in the non-paginated view mode. The method may further include in response to a request to display the content of the presentation document in a content toggling view mode, causing display of the content of the presentation document in the content toggling view mode, the content toggling view mode including the content of the presentation document displayed in a full-screen pane configured to provide toggle-based navigation in which a third user input causes an automatic advance of the content of the presentation document to a respective presentation segment identified within the content of the presentation document.

The method may further include causing display of a presentation generation selection window in the graphical user interface, the presentation generation selection window including a text input field for receiving the natural language input, and a presentation parameter selection element for receiving a user selection of a presentation parameter. The instruction to generate the presentation may include the user-selected presentation parameter, and the presentation generation prompt may further include the user-selected presentation parameter. The method may further include generating a constraint for the presentation parameter selection element based at least in part on the natural language input, and displaying the constraint for the presentation parameter selection element in the presentation generation selection window.

The method may further include extracting a user content sample from at least one other document generated by a user, and the presentation generation prompt may further include the user content sample. Generating the presentation generation prompt may include identifying, in the user-generated document, a data structure referencing a separate document, generating a unique identifier for the data structure, and including the unique identifier in the presentation generation prompt, and generating the set of candidate presentation segments may include identifying the unique identifier in the generative response, and replacing the unique identifier with the data structure. Analyzing the natural language input to determine the user intent parameter for the presentation may include selecting the user intent parameter from a set of predetermined user intent parameters. The method may further include, while content of the presentation document is displayed in the graphical user interface in the non-paginated view mode, receiving a change to the content of the presentation document.

The user-generated document may include a plurality of content headings, and the presentation generation prompt may include an instruction to generate a respective presentation segment for each respective content heading.

The method may further include generating a set of presentation slides, the generating including generating a respective presentation slide for each respective presentation segment of the presentation document.

A computer-implemented method of generating a presentation from a user-generated document may include causing display of a graphical user interface of a client application operating on a client device, the graphical user interface including a content pane configured to display a user-generated document, receiving, from the graphical user interface, a selection of a user-generated document from which to generate a presentation document, analyzing the user-generated document to identify a content property of the user-generated document, generating a constraint for a presentation parameter based at least in part on the content property, causing display of a presentation generation selection window in the graphical user interface, the presentation generation selection window including a text input field for receiving a natural language input and a presentation parameter selection element for receiving a user selection of the presentation parameter, extracting user-generated content from the user-generated document, and generating a set of candidate presentation segments for the presentation document. Generating the set of candidate presentation segments may include generating a presentation generation prompt including predetermined query prompt text, the extracted user-generated content, at least a portion of the natural language input, and the user selection of the presentation parameter, providing the presentation generation prompt to a generative output engine, and receiving a generative response from the generative output engine. The method may further include, based on the generative response, generating a set of candidate presentation segments, causing the set of candidate presentation segments to be displayed in a presentation preview window of the graphical user interface, in response to a first user input accepting the set of candidate presentation segments, generating a presentation document including the set of candidate presentation segments, storing the presentation document in association with a document platform, and causing display of content of the presentation document in the graphical user interface in a content toggling view mode, the content toggling view mode including the content of the presentation document displayed in a full-screen pane configured to provide toggle-based navigation in which a second user input causes an automatic advance of the content of the presentation document to a respective presentation segment identified within the content of the presentation document.

The method may further include receiving, in the presentation preview window, a third user input modifying a candidate presentation segment of the set of candidate presentation segments, thereby producing a modified set of candidate presentation segments, and generating the presentation document includes generating the presentation document to include the modified set of candidate presentation segments. The method may further include, prior to causing display of content of the presentation document in the content toggling view mode, causing display of content of the presentation document in a non-paginated view mode providing continuous scrolling of the presentation document. The method may further include analyzing the natural language input to determine a user intent parameter for the presentation, and the presentation generation prompt may further include the user intent parameter.

The presentation parameter may be a number of presentation segments to include in the presentation document, and the constraint for the presentation parameter may be based on a length of the user-generated document. The constraint may include a maximum number of presentation segments and a minimum number of presentation segments. The presentation parameter selection element may include a slider element that allows a selection of the presentation parameter between the maximum number of presentation segments and the minimum number of presentation segments.

A system includes one or more processing units and computer readable memory storing computer readable instructions that when executed by the one or more processing units cause the system to cause display of a graphical user interface of a client application operating on a client device, the graphical user interface including a content pane configured to display a user-generated document, receive, from the graphical user interface, a selection of a user-generated document from which to generate a presentation document, extract user-generated content from the user-generated document, identify, in the user-generated content, a data structure referencing a separate document, generate a unique identifier for the data structure, incorporate the unique identifier into the extracted user-generated content, and generate a set of candidate presentation segments for the presentation document. Generating the set of candidate presentation segments may include generating a presentation generation prompt including predetermined query prompt text and the extracted user-generated content, providing the presentation generation prompt to a generative output engine, and receiving a generative response from the generative output engine. The computer readable instructions may further cause the system to, based on the generative response, generate a set of candidate presentation segments, including identifying the unique identifier in the generative response and replacing the unique identifier with the data structure, cause the set of candidate presentation segments to be displayed in a presentation preview window of the graphical user interface, in response to a first user input accepting the set of candidate presentation segments, generate a presentation document including the set of candidate presentation segments, store the presentation document in association with a document platform, and cause display of content of the presentation document in the graphical user interface in a content toggling view mode, the content toggling view mode including the content of the presentation document displayed in a full-screen pane configured to provide toggle-based navigation in which a second user input causes an automatic advance of the content of the presentation document to a respective presentation segment identified within the content of the presentation document. When displayed in the content toggling view mode, the data structure may be replaced by content extracted from a source referenced by the data structure. The computer readable instructions further cause the system to receive, in the presentation preview window, a third user input modifying an order of the set of candidate presentation segments, and generating the presentation document may include generating the presentation document according to the modified order of the set of candidate presentation segments. The computer readable instructions further cause the system to, prior to causing display of content of the presentation document in the content toggling view mode, cause display of content of the presentation document in a non-paginated view mode, and receive a fourth user input modifying at least one candidate presentation segment of the set of candidate presentation segments. Generating the presentation document may include generating the presentation document to include the modified at least one candidate presentation segment.

### BRIEF DESCRIPTION OF THE DRAWINGS

In the drawings:

FIG. 1 depicts an example system in which various features of the present disclosure may be implemented.

FIG. 2 depicts an example system in which a presentation service may interact with a generative output system for generating presentation documents.

FIGS. 3A-3B depict an example operation for generating a presentation document from one or more user-generated documents.

FIGS. 4A-4I depict example graphical user interfaces for receiving a selection of a user-generated document and generating and displaying a presentation document based on the user-generated document.

FIG. 5 depicts an example process for generating a presentation document.

FIG. 6 depicts a system diagram and network/communication architectures that may support a system as described herein.

FIG. 7 depicts a functional system diagram of network/communication architectures that may support a system as described herein.

FIG. 8 depicts a simplified system diagram and data processing pipeline.

FIG. 9 depicts a system providing multiplatform prompt management as a service.

FIG. 10 shows a sample electrical block diagram of an electronic device that may perform the operations described herein.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION OF THE EMBODIMENTS

In the following description numerous specific details are set forth in order to provide a thorough understanding of the claimed invention. It will be apparent, however, that the claimed invention may be practiced without these specific details. In some instances, well-known structures and devices are shown in block diagram form in order to avoid unnecessary obscuring.

The present disclosure is generally directed to generating presentation documents from user-generated documents, such as user-generated documents that are created, stored, and accessed in a document platform. For example, a document platform may provide an environment in which users can create, edit, store, view, collaborate on, and share documents. Such documents may contain myriad types of information and for myriad purposes. In many cases, such documents may include large amounts of information, which may not be particularly well suited for a presentation. For example, a document that outlines the entire scope of a software project may not be well suited for use as the text or slides of a presentation, as it may include too much information to be usefully displayed or addressed in a presentation. Creating presentations from underlying documents or information may be time consuming, however, as an individual needs to digest the information, determine what portions of the information should be included in the presentation, generate text, images, and/or other visual content for the presentation, and generate the actual presentation files and/or media. Such tasks may be time consuming and inefficient. Accordingly, described herein is a presentation service for automatically generating presentation documents from underlying user-generated documents in a document platform.

The presentation service may use a generative output system to generate presentation documents from user-generated documents of a document platform. Further, the presentation service may generate customized presentation documents that conform to a user's specific preferences, as provided in one or more natural language inputs and/or other selections. For example, a user may specify the tone, length, complexity, audience, and/or other parameters for the presentation document. Additionally, the presentation service may determine certain constraints or limitations for the presentation based on the selected underlying user-generated documents. For example, the presentation service may impose a constraint on the number of slides or presentation segments for the presentation based on the length of the underlying document(s) and/or the amount or type of content in the underlying document(s). The presentation service may present such constraints to the user before generating the presentation so that the user can make an informed decision for the presentation content based on the actual source content.

The presentation service ultimately generates a presentation document that is based on one or more selected user-generated documents, and that is configured for presentation in the document platform. For example, a document platform may be configured to display documents, including presentation documents, in several modes, including a non-paginated mode, in which the documents can be continuously scrolled (and optionally edited), and in a full-screen presentation mode that provides toggle-based navigation in which the document may advance through presentation segments by selectively emphasizing and deemphasizing presentation segments (e.g., visually) to indicate the active presentation segment. Thus, the presentation service described herein may generate presentation documents that are configured for display in the full-screen presentation mode, as well as other modes (e.g., a slideshow).

As used herein, a non-paginated view mode may provide for continuous scrolling of a user-generated document. In some cases, a non-paginated view mode may provide for continuous scrolling of a document without regard to any page or content section divisions (e.g., pages, slides, content sections, or the like). In some cases, a user-generated document may not have fixed page divisions, and when displayed in a non-paginated view mode, the document may be continuously scrollable in accordance with the lack of fixed page divisions. In some cases, a user-generated document includes fixed page divisions, and when displayed in a non-paginated view mode, the fixed page divisions are ignored or otherwise do not interrupt the continuous scrolling operations of the non-paginated view mode. In such cases, page divisions may be visually represented in the displayed document, such as with a dotted line or other indicia, or they may not be visually represented. Moreover, in a non-paginated view mode, content from different pages, content sections, slides, or other segment of a document or content item may be displayed at the same time and/or in an overlapping manner (e.g., as a user scrolls through a document in a non-paginated view mode, content from a next page may appear as soon as it is scrolled to, even while content from the current or previous page remains visible). As used herein, content sections may correspond to content that is distinguished from other content, such as via a page break, section break, heading or header, title, subject matter, or other content-based or format-based delineation.

The presentation service may also generate presentation documents that retain certain types of platform-specific content from the underlying document. For example, a document platform may allow a user to integrate selectable graphical objects in documents. The selectable graphical objects may refer to another content item, and may, when selected, cause the graphical user interface of the document platform to be redirected to the content item viewed in a native platform for that content item. As described herein, a selectable graphical object may include metadata and other content extracted from the referenced content item, and may cause the graphical user interface to render the extracted content in a panel, card or other graphical element of the selectable graphical object. These selectable graphical objects may correspond to or be defined by data structures that are incorporated into a document. However, since such data structures are not simply natural-language text content, they may not be compatible with generative output services, or they may be lost during automatic presentation generation. Accordingly, the presentation service described herein may be configured to process the underlying documents in order to preserve such data structures and incorporate them into the automatically generated presentation documents.

### Scalable Network Architecture for Automatic Content Generation

As described herein, the presentation service may use content generation tools for various aspects of the presentation service, including generating presentation documents from one or more underlying user-generated documents, and the like. More specifically, systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input. Many of the examples described herein are directed to an interface that includes an input region that can receive support requests, questions, commands, references to content, links, and other input, at least a portion of which is provided as natural language text.

In some examples, the user may provide natural language inputs to a text input box or field of a support interface. The user-supplied natural language inputs may be used to formulate various prompts for a generative service, as described herein.

In some examples, the user may engage with a button in a UI that causes the generative interface panel or a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task.

Regardless of how a software platform user interface is instrumented to receive user input, the user may provide an input that includes a string of text including a natural language input. The input may be used to generate various prompts, which may in turn be provided as input to an input queue including other requests from other users or other software platforms. Once the prompt is popped from the queue, it may be normalized and/or preconditioned by a preconditioning service. The preconditioning service may be provided by one or more registered plugins that are selected in accordance with an analysis of the input and/or context of the current session.

The preconditioning service can, without limitation: append additional context to the user's raw input; generate a prompt that includes a portion of the user's raw input in addition to metadata associated with the user's service request, insert the user's raw input into a template prompt selected from a set of prompts (also referred to herein as “predetermined query prompt text” or “predetermined prompt text”); replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated prompt can be provided as input to a secondary queue that meters and orders requests from one or more software platforms to a generative output system, such as described herein.

### Large Language Models

An example of a generative output engine of a generative output system as described herein may be a large language model (LLM). An LLM may include a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phrase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. An LLM is typically trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a nearly limitless number of probabilistically reasonable next words, phrases, punctuation, and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation can be selected or generated using a number of techniques. In many cases, a continuation of an input prompt may be referred to more generally as “generated text” or “generated output” provided by a generative output engine as described herein.

Fundamentally all written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, the generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=‘https://example link/123456<project 123456</a>’”. In addition, the LLM may be configured to replace the substring “pending” with a real-time updating token associated with an API call to the project management system. In this manner, the LLM converts a static string within the document management system into richer content that facilitates convenient and automatic cross-linking between software products, and may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilitates bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of attention mechanisms, including self-attention mechanisms, may be suitable.

In response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations. In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoints, such as for configuration or for receiving input prompts. The generative output application can be further configured to provide generated text output to one or more subscribers or API clients. Many suitable interfaces can be configured to provide input to and receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:
{
   “prompt”: “Generate five words of placeholder text in the English language.”,
   “API_KEY: “hx-Y5u4zx3kaF67AzkXK1hC”,
   “user_token”: “PkcLe7Co2G-50AoIVojGJ”
}

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:
{
   “response”: “Hello world text goes here.”,
   “generation_time_ms”: 2
}

In some embodiments, a prompt provided as input to a generative output engine can be engineered from user input. For example, in some cases, a user input can be inserted into an engineered template prompt that itself is stored in a database and includes text that may be referred to as predetermined query prompt text or predetermined prompt text. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, an input (e.g., a natural language input associated with a support request, a prompt, etc.) received from a user can be preconditioned and/or parsed to extract certain content therefrom. The extracted content can be used to inform selection of a particular engineered prompt template from a database of engineered prompt templates including predetermined query prompt text or predetermined prompt text. Once the selected prompt template is selected, the extracted content can be inserted into the template to generate a populated engineered prompt template that, in turn, can be provided as input to a generative output engine as described herein. Prompts may also be generated by another service, engine, or operation of a presentation service or other software service described herein, and may include content from a user input. Content extraction, prompt configuration, and prompt selection may be performed by a processing plugin that is registered or otherwise available to a generative service.

In many cases, a particular engineered prompt template can be selected based on a desired task for which output of the generative output engine may be useful to assist. For example, if a user requires a summary of a particular document, the user input prompt may be a text string comprising the phrase “generate a summary of this document.” A software instance configured for prompt preconditioning—which may be referred to as a “preconditioning software instance,” “prompt preconditioning software instance,” “processing plugin,” or “plugin”—may perform one or more substitutions of terms or words in this input phrase, such as replacing the demonstrative pronoun phrase “this document” with an unambiguous unique document ID. In this example, preconditioning software instance can provide an output of “generate a summary of the document with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences.

For example, in an embodiment, the preconditioning software instance can insert a phrase that adds contextual information describing the user making the initial input and request. In this example, output of the prompt preconditioning instance may be “generate a summary of the document with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports; metadata or other data or information associated with a software application from which a user input originated; and so on. For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a document identifier that corresponds to that user's personal space and the document that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into document 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this document made by my team since I last visited this document” could determine the user's ID, team members with close connections to that user based on a user graph, determine that the user last visited the document three weeks prior, and filter attribution of edits within the last three weeks to the current document ID based on those team members. With these modifications, the prompt provided to the generative output engine may be:
{
   “raw_prompt”: “summarize the edits to this document made by my team since I last visited this document”,
   “modified_prompt”: “Generate a summary of each paragraph tagged with an editId attribute matching editId=1, editId=51, editId=165, editId=99 within the following HTML-formatted content: [HTML-formatted content of the document].”
}

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:
{
   “snippet123_table_from_tasks”: “The table should be formatted as a three-column table with multiple rows. The leftmost column should be titled ‘Title’ and the corresponding content of each row of this column should be the title attribute of a task. The middle column should be titled ‘Created Date’ and the corresponding content of each row of this column should be the creation date of the task. The rightmost column should be titled ‘Status’ and the corresponding content of each row of this column should be the status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:
{
   “modified_prompt”: “Find all tasks assigned to User 1234 dating from Jan. 1, 2023-Jan. 14, 2023 (inclusive). Create a table in which each found task corresponds to a respective row of that table. The table should be formatted as a markdown table, in plain text, with three columns. The leftmost column should be titled ‘Title’ and the corresponding content of each row of this column should be the title attribute of a respective task. The middle column should be titled ‘Created Date’ and the corresponding content of each row of this column should be the creation date of the respective task. The rightmost column should be titled ‘Status’ and the corresponding content of each row of this column should be the status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents.

In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each document or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url.”

In yet other examples, a prompt engineering service may be configured to classify a user input into one of a number of classes of request. Different classes of request may be associated with different permissions handling techniques. For example, a class of request that requires a generative output engine to resource from multiple documents may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein. More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated with Generative Output Systems

In particular, embodiments described herein are focused on leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. For example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine (and/or a presentation service that uses a generative output engine), as described herein, in order to automatically generate structured or unstructured content within environments defined by those systems more generally. For example, a documentation system (and/or a presentation service associated with the documentation system) can leverage a generative output engine to, without limitation: generate presentation documents; summarize individual documents; summarize portions of documents; summarize multiple selected documents; generate document templates; generate document section templates; generate suggestions for cross-links to other documents or platforms; generate suggestions for adding detail or improving conciseness for particular document sections; and so on.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multitenant software platform.

For simplicity of description, the multitenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform—multitenant or otherwise—as described herein are not collocated, and communicate over a large area and/or wide area network by leveraging one or more networking protocols, but this is not required of all implementations.

A frontend of a software platform as described herein may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multitenant software platform. In many embodiments, as noted above, tenant-owned content may be stored, transmitted, and/or formatted for display by a frontend of a software platform as structured data. In particular structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third-party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multitenant software and, in particular, by a provider of suites of multitenant software platforms, each platform being configured for a different particular purpose. Herein, providers of systems or suites of multitenant software platforms are referred to as “multiplatform service providers.” Generally, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multitenant issue tracking system, a multitenant code repository service, and a multitenant documentation service. In this example, an organization that is a customer/client of the service provider may be a tenant of each of the issue tracking system, the code repository service, and the documentation service.

As with preceding examples, the organization can create and/or purchase user accounts for its employees, so that certain selected employees have access to one or more of issue tracking functionality, documentation functionality, and code repository functionality.

In this example and others, a system may leverage multiple collaboration tools to advance individual projects or goals. For example, for a single software development project, a software development team may use (1) a code repository to store project code, executables, and/or static assets, (2) a documentation service to maintain documentation related to the software development project, (3) an issue tracking system to track assignment and progression of work, and (4) a messaging service to exchange information directly between team members.

However, as organizations grow, as project teams become larger, and/or as software platforms mature and add features or adjust user interaction paradigms over time, using multiple software platforms can become inefficient for both individuals and organizations. To counteract these effects, many organizations define internal policies that employees are required to follow to maintain data freshness across the various platforms used by an organization.

For example, when a developer submits a new pull request to a repository service, that developer may also be required by the organization to (1) update a description of the pull request in a documentation service, (2) change a project status in a project management application, and/or (3) close a ticket in a ticketing or issue tracking system relating to the pull request. In many cases, updating and interacting with multiple platforms on a regular and repeating basis is both frustrating and time consuming for both individuals and organizations, especially if the completion of work of one user is dependent upon completion of work of another user.

Some solutions to these and related problems often introduce further issues and complexity. For example, many software platforms include an in-built automation engine that can expedite performance of work within that software platform. In many cases, however, users of a software platform with an in-built automation engine may not be familiar with the features of the automation engine, nor may those users understand how to access, much less efficiently utilize, that automation engine. For example, in many cases, accessing in-built automation engines of a software platform requires diving deep into a settings or options menu, which may be difficult to find.

Other solutions involve an inter-platform bridge software that allows data from one platform to be accessed by another platform. Typically, such bridging software is referred to as an “integration” between platforms. An integration between different platforms may allow content, features, and/or functionality of one platform to be used in another platform.

For example, a multiplatform service provider may host an issue tracking system and a documentation system. The provider may also supply an integration that allows issue tracking information and data objects to be shown, accessed, and/or displayed from within the documentation system. In this example, the integration itself needs to be separately maintained in order to be compliant with an organization's data sharing and/or permissions policies. More specifically, an integration must ensure that authenticated users of the documentation system that view a document that references information stored by the issue tracking system are also authorized to view that information by the issue tracking system.

Phrased in a more general way, an architecture that includes one or more integrations between tenancies of different software platforms requires multiple permissions requests that may be forwarded to different systems, each of which may exhibit different latencies, and have different response formats, and so on. More broadly, some system architectures with integrations between software platforms necessarily require numerous network calls and requests, occupying bandwidth and computational resources at both software platforms and at the integration itself, to simply share and request information and service requests for information by and between the different software platforms. This architectural complexity necessitates careful management to prevent inadvertent information disclosure.

Furthermore, the foregoing problem(s) with maintaining integrations' compliance with an organization's policies and organization-owned content access policies may be exacerbated as a provider's platform suite grows. For example, a provider that maintains three separate platforms may choose to provide three separate integrations interconnecting all three platforms. (e.g., 3 choose 2). In this example, the provider is also tasked with maintaining policy compliance associated with those three platforms and three integrations. If the provider on-boards yet another platform, a total of six integrations may be required (e.g., 4 choose 2). If the provider on-boards a fifth platform, a total of ten integrations may be required (e.g., 5 choose 2). Generally, difficulties of maintaining integrations between different software platforms (in a permissions policy compliant manner) scales exponentially with the number of platforms provided.

Further to the inadvertent disclosure risk and maintenance obligations associated with inter-platform integrations, each integration is still only configured for information sharing, and not automation of tasks. Although context switching to copy data between two integrated platforms may be reduced, the quantity of tasks required of individual users may not be substantially reduced.

Further solutions involve creating and deploying dedicated automation platforms that may be configured to operate with one, and/or perform automations of, or more platforms of a multiplatform system. These, however, much like automation engines in-built to individual platforms, may be difficult to use, access, or understand. Similarly, much like integrations described above, dedicated automation platforms require separate maintenance and employee training, in addition to licensing costs and physical or virtual infrastructure allocations to support the automation platform(s).

In still further other circumstances, many automations may take longer for a user to create than the time saved by automating that particular task. In these examples, individual users may avoid defining automations altogether, despite that, in aggregate, automation of a given task may save an organization substantial time and cost.

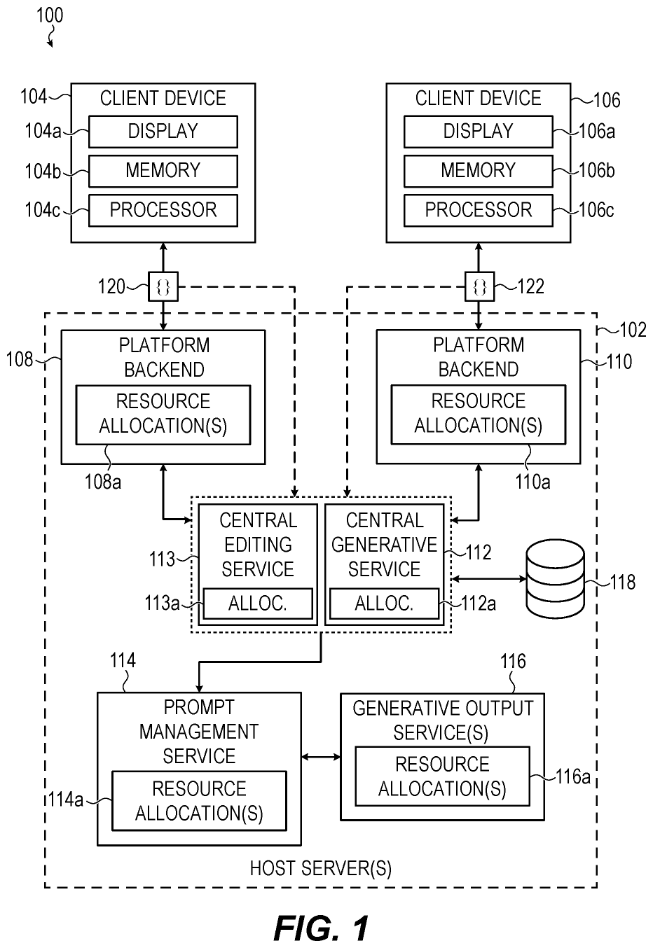

These foregoing and other embodiments are discussed below with reference to FIGS. 1-10. However, the detailed description given herein with respect to these figures is for explanation only and should not be construed as limiting.

FIG. 1 depicts a simplified diagram of a system, such as described herein that can include and/or may receive input from a generative output engine as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other example software platforms include presentation services, ITSM systems, chat platforms, messaging platforms, and the like. These backends can be communicably coupled to a generative output engine that can be leveraged to provide unique intelligent functionality to each respective backend. For example, the generative output engine can be configured to receive prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular document of the documentation platform. A comprehensive continuation/response to this summary request may pull data or information from the issue tracking system, as well.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each communicably couple to a centralized generative service 112.

The centralized generative service 112 can be configured to cause rendering of a frame or panel within respective frontends of each of the first platform backend 108 and the second platform backend 110. In this manner, and as a result of this construction, each of the first platform and the second platform present a consistent user content editing experience for accessing generative services including the automated assistant services and other operations described herein.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized generative service 112 that can be called by each respective frontend whenever it is required to present the user of that respective frontend with a generative interface that may facilitate a chat-based exchange with one or more automated assistant services.

The documentation platform's frontend may call upon the centralized generative service 112 to assist with content discovery and creation with respect to documents managed by the documentation platform. Similarly, the issue tracking platform's frontend may call upon the centralized generative service 112 to perform content discovery, generation, and management of issues or tickets managed by the issue tracking platform.

Similarly, the software platforms may issue prompts to the centralized generative service 112 to support user interactions or services that are not direct user requests for generative outputs. For example, a software platform (e.g., a presentation service) may utilize the centralized generative service 112 to generate presentation documents based on one or more selected user-generated documents and user-defined presentation specifications.

The system 100 may also include a centralized content editing frame service 113, which can operate an editor or editing service for each of multiple platforms. More specifically, the centralized content editing frame service 113 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor. The centralized content editing frame service 113 can parse text input provided by users of the documentation platform frontend and/or the issue tracking platform backend, monitoring for command and control keywords, phrases, trigger characters, and so on. In many cases, for example, the centralized content editing frame service 113 can implement a slash command service that can be used by a user of either platform frontend to issue commands to the backend of the other system.

For example, the user of the documentation platform frontend can input a slash command to the content editing frame, rendered in the documentation platform frontend supported by the centralized content editing frame service 113, in order to type a prompt including an instruction to create a new issue or a set of new issues in the issue tracking platform. Similarly, the user of the issue tracking platform can leverage slash command syntax, enabled by the centralized content editing frame service 113, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; content editing elements can include and/or may be implemented to include many features, which may vary from embodiment to embodiment. For simplicity of description the embodiments that follow reference a centralized content editing frame service 113 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized content editing frame service 113 can be extended to include additional features and functionality-such as a slash command and control feature-which, in turn, can automatically be leveraged by any further platform that incorporates a content editing frame, and/or otherwise integrates with the centralized content editing frame service 113 itself. In this example, slash commands facilitated by the editor service can be used to receive prompt instructions from users of either frontend. These prompts can be provided as input to a prompt engineering/prompt preconditioning service (such as the prompt management service 114) that, in turn, provides a modified user prompt as input to a generative output service 116.

Similar functionality can also be provided by the centralized generative service 112. For example, as described herein the centralized generative service 112 may provide a chat-based interface in a panel or region of a frontend application. Through a series of natural language inputs, the system may provide content discovery, content modification, content generation, or content management operations. In some cases, the centralized generative service 112 utilizes a variety of software plugins and/or automated assistant services to provide the requested operations. The centralized generative service 112 may generate prompts, which, in this example, can be provided as input to a prompt engineering/prompt preconditioning service (such as the prompt management service 114) that, in turn, provides a modified user prompt as input to a generative output service 116.

The generative output service may be hosted over the host servers 102 or, in other cases, may be a software instance instantiated over separate hardware. In some cases, the generative engine service may be a third-party service that serves an API interface to which one or more of the host services and/or preconditioning service can communicably couple. The generative output engine can be configured as described above to provide any suitable output, in any suitable form or format. Examples include content to be added to user-generated content, API request bodies, replacing user-generated content, and so on. Additional examples include recommended data item queries, filtered lists of data item queries, relevance scores or rankings of recommended data item queries, natural language query prompt text for eliciting responses to data item queries, and the like.

The centralized content editing frame service 113 and/or the centralized generative service 112 can be configured to provide suggested prompts to a user as the user types. For example, as a user begins typing a slash command in a frontend of some platform that has integrated with a centralized content editing frame service 113 as described herein, the centralized content editing frame service 113 can monitor the user's typing to provide one or more suggestions of prompts, commands, or controls (herein, simply “preconfigured prompts”) that may be useful to the particular user providing the text input. Similarly, the centralized generative service 112 may monitor the user's typing and provide one or more suggestions of prompts, commands, or controls. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized content editing frame service 113 and/or the centralized generative service 112 can be configured to suggest one or more prompts that can be provided as input to a generative output engine as described herein to perform a useful task, such as summarizing content rendered within the centralized content editing frame service 113, reformatting content rendered within the centralized content editing frame service 113, inserting cross-links within the centralized content editing frame service 113, and so on.

The ordering of the suggestion list and/or the content of the suggestion list may vary from user to user, user role to user role, and embodiment to embodiment. For example, when interacting with a documentation system, a user having a role of “developer” may be presented with prompts associated with tasks related to an issue tracking system and/or a code repository system. Alternatively, when interacting with the same documentation system, a user having a role of “human resources professional” may be presented with prompts associated with manipulating or summarizing information presented in a directory system or a benefits system, instead of the issue tracking system or the code repository system. More generally, in some embodiments described herein, a centralized content editing frame service 113 and/or the centralized generative service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content editing frame service 113 and/or the centralized generative service 112, as described herein, can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein reference systems and methods for sharing user interface elements rendered by a centralized content editing frame service 113 and features thereof (such as a slash command processor), between different software platforms in an authenticated and secure manner. For simplicity of description, the embodiments that follow reference a configuration in which a centralized content editing frame service is configured to implement a slash command feature—including slash command suggestions—but it may be appreciated that this is merely one example, and other configurations and constructions are possible. Similarly, the centralized generative service 112 may be configured to implement a variety of commands initiated using a command character (e.g., a slash, @, or other special symbol), can be used to invoke various assistant services, plugins, or other operations from the generative interface.

The first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized content editing frame service 113 and the centralized generative service 112. Information can be transacted by and between the frontend, the first platform backend 108 and the centralized content editing frame service 113 and the centralized generative service 112 in any suitable manner, form, or format. In many embodiments, as noted above, the client device 104 and in particular the first platform frontend can be configured to send an authentication token 120 along with each request transmitted to any of the first platform backend 108 or the centralized content editing frame service 113, the centralized generative service 112, the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized content editing frame service 113 and the centralized generative service 112. Information can be transacted by and between the frontend, the second platform backend 110 and the centralized content editing frame service 113 and the centralized generative service 112 in any suitable manner, form, or format. In many embodiments, as noted above, the client device 106 and in particular the second platform frontend can be configured to send an authentication token 122 along with each request transmitted to any of the second platform backend 110 or the centralized content editing frame service 113 and the centralized generative service 112.

As a result of these constructions, the centralized content editing frame service 113 and the centralized generative service 112 can provide uniform feature sets to users of either the client device 104 or the client device 106. For example, the centralized content editing frame service 113 can implement a slash command processor to receive prompt input and/or preconfigured prompt selection provided by a user of the client device 104 to the first platform and/or to receive input provided by a different user of the client device 106 to the second platform.

In some cases, the graphical user interfaces of the platform frontends may include a presentation service graphical user interface, which may be associated with a presentation service. The presentation service graphical user interface may be a component of a graphical user interface of a particular software platform, such as a document platform, or a component of a graphical user interface of a presentation service that provides presentation services for multiple software platforms. Stated another way, a presentation service graphical user interface may be integrated into the graphical user interface of a software platform that the presentation service supports, and/or a presentation service may be instantiated as its own software platform that includes a graphical user interface that is separate and/or distinct from other content platforms (and which may provide presentation service for one or more software platforms or other subjects, contexts, or the like).

The centralized content editing frame service 113 and the centralized generative service 112 may ensure that common features are available to frontends of different platforms. One such class of features provided by the centralized content editing frame service 113 and the centralized generative service 112 invokes output of a generative output engine of a service such as the generative engine output service 116.

For example, as noted above, the generative output service 116 can be used to generate content, analyze content, supplement content, and/or generate API requests or API request bodies that cause one or both of the first platform backend 108 or the second platform backend 110 to perform a task. In some cases, an API request generated at least in part by the generative output service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized content editing frame service 113 and the centralized generative service 112, or to receive prompts or other input from services and/or software platforms, such as presentation services. The user input may include a prompt to be continued by the generative output service 116.

The prompt management service 114 can be configured to modify the user input, to supplement the user input, select a prompt from a database (e.g., the database 118) based on the user input, insert the user input into a template prompt, replace words within the user input, perform searches of databases (such as user graphs, team graphs, and so on) of either the first platform backend 108 or the second platform backend 110, change grammar or spelling of the user input, change a language of the user input, and so on. The prompt management service 114 may also be referred to herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible). In instances where a service or software platform (e.g., a presentation service) generates prompts for the generative output service 116, the prompt management service 114 may be bypassed, and the service or software platform may structure its prompts as an API request to the generative output surface 116. In other examples, prompts or prompt requests from a service or software platform are provided to the prompt management service 114 for processing to produce the modified or preconditioned prompt for the generative output service 116.

In response to receiving a prompt (e.g., a modified prompt and/or a properly formatted prompt directly from a service or software platform) as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114 or the service or software platform that issued the prompt. In other cases, output of the generative output service 116 can be provided to the centralized content editing frame service 113 or the centralized generative service 112 to return to a suitable backend application, to in turn return to or perform a task for the benefit of a client device such as the client device 104 or the client device 106. More particularly, it may be appreciated that although FIG. 1 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized content editing frame service 113, the centralized generative service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative output service 116.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to ${user} with a due date in the next 2 days.” In this example, the token/field/variable ${user} can be replaced with a user identifier corresponding to the user currently operating a client device. The templatized prompts or the static portions thereof may be referred to as predetermined query prompt text or predetermined prompt text.

This insertion of an unambiguous user identifier can be performed by the client device, the platform backend, the centralized content editing frame service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user123 with a due date in the next 2 days” can be retrieved from a database or other memory, and provided as input to the generative output service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt}. Provide output of any table in the form of a tab delimited table formatted according to the markdown specification.” In this example, the variable ${user prompt} may be replaced with the user prompt such that the entire prompt received by the generative output service 116 can include the user prompt and the example sentence describing how a table should be formatted.

In yet other embodiments, a suggestion may be generated by the generative output service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative output service 116 may generate a set of JSON objects that, when received by the Kanban platform, are rendered as a set of cards in a Kanban board, each card including a different title and description corresponding to different tasks that may be associated with steps for creating a new iced cream flavor. In this manner, the user can quickly be presented with an example set of initial tasks for a new project.

In yet other examples, suggestions can be configured to select or modify prompts that cause the generative output service 116 to interact with multiple systems. For example, a suggestion in a documentation system may be to create a new document content section that summarizes a history of agent interactions in an ITSM system. In some cases, the generative output service 116 can be called more than once and/or it may be configured to generate its own follow-up prompts or prompt templates which can be populated with appropriate information and re-submitted to the generative output service 116 to obtain further generative output. More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. Many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a. Similarly, the second platform backend 110 may be instantiated over the resource allocations 110a (including processors, memory, storage, network communications systems, and so on). The centralized content editing frame service 113 is supported by a processor and memory and network connection (and/or database connections) collectively represented for simplicity as the resource allocations 113a. The centralized generative service 112 is supported by a processor and memory and network connection (and/or database connections) collectively represented for simplicity as the resource allocations 112a. The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect keywords or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized content editing frame service 113 or a centralized generative service 112.

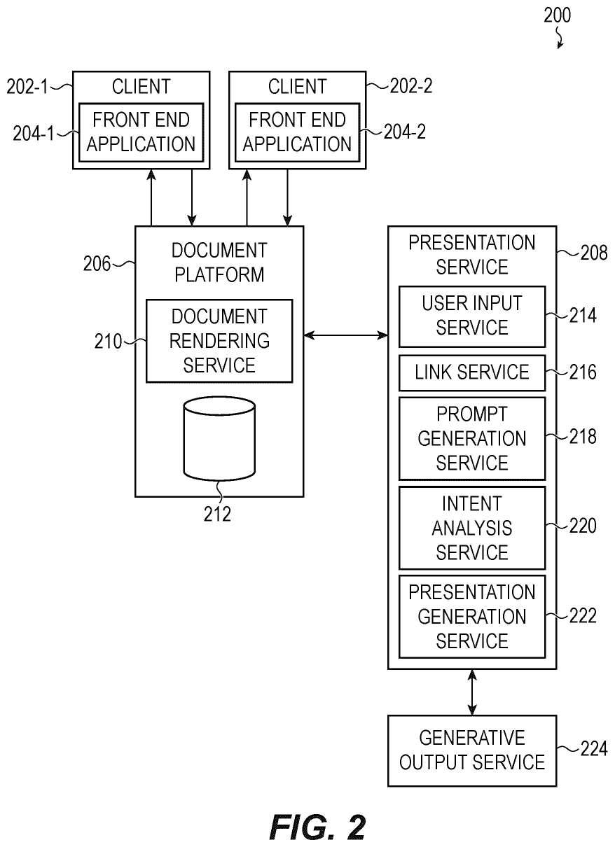

FIG. 2 depicts an example system 200 in which a presentation service 208 may provide presentation generation services for software platforms, such as a document platform 206. More particularly, a presentation service 208 may receive requests, from users of the document platform 206 (or another platform, service, or software), that include an identifier of an underlying document or content item, and optionally additional constraints, context, instructions, or requirements. The presentation service 208 may use a generative output system to generate presentation documents from the underlying document or content item.

The system 200 includes clients 202 (202-1, 202-2). The clients can be implemented as any suitable electronic device. In many embodiments, the client devices 202 are personal computing devices such as desktop computers, laptop computers, or mobile phones. The clients 202 execute respective frontend applications 204 (204-1, 204-2). The frontend applications 204 may be frontend applications of the document platform 206. For example, the frontend applications may instantiate graphical user interfaces with which users may interact with the document platform 206. In some cases, the frontend applications may instantiate graphical user interfaces and/or graphical user interface elements of another service, such as the presentation service 208, within the graphical user interface of the document platform. In other cases, the clients 202 may execute a frontend application of the presentation service 208 separate from a frontend application of the document platform 206. In some cases, the frontend applications 204 are frontend applications of other software platforms, such as an issue tracking platform, a codebase platform, a knowledge base platform, (or any other software platform described herein), and the frontend applications 204 may instantiate a graphical user interface for accessing the underlying service.

Where the frontend applications 204 are frontend applications of the document platform 206, the frontend applications may facilitate functions such as generating, storing, editing, sharing, and collaborating on user-generated documents. Additionally, the frontend applications 204 may facilitate generating, storing, editing, sharing, and collaborating on presentation documents (e.g., with the presentation service 208 via the document platform 206), as described herein.

In some cases, the presentation service 208 is a centralized presentation service 208 that provides presentation services for multiple software platforms (e.g., multiple document platforms, and/or other types of software platforms). For example, each software platform may be configured to interface with the presentation service 208 in order to access the functionality provided by the presentation service 208. As described herein, the presentation service 208 may be configured to provide tailored presentation services to each software platform. Stated another way, the presentation service 208 may be configured as a platform-independent presentation engine that can provide tailored presentation services for different software platforms by accessing information that is unique to those software platforms.

As described herein, the document platform 206 facilitates various document functionalities, including without limitation generating, storing, editing, sharing, and collaborating on user-generated documents. The document platform 206 may include a document rendering service 210 and a document store 212. The document store 212 stores documents and/or other data of the document platform 206. The document rendering service 210 is configured to render or otherwise process documents for display in a graphical user interface of the document platform 206. The document rendering service 210 may also be configured to identify, process, and render data structures such as selectable graphical objects in the user-generated documents of the document platform 206. For example, the document platform 206 may allow a user to integrate selectable graphical objects in documents, wherein the selectable graphical objects refer to another content item, and may cause the graphical user interface of the document platform 206 to be redirected to the content item viewed in a native platform for that content item. The document rendering service 210 may identify such data structures, extract content from the referenced content item, and cause the graphical user interface to render the extracted content in a panel, card or other graphical element within a document.

The document platform 206 may interface with the presentation service 208 to provide presentation generation functionality within the document platform 206. The document platform 206 may provide graphical user interface elements that allow users to request presentation documents based on underlying user-generated documents and to provide inputs that define parameters, constraints, or other aspects of the presentation documents to be generated. The presentation service 208 may also receive and display proposed presentation segments, accept modifications to the segments, and ultimately store and display presentation documents (among other possible functions, including editing, sharing, collaborating, publishing, etc., of presentation documents).

The presentation service 208 generally provides presentation generation functionality for the document platform 206 (or other platforms associated with content that may be used to generate presentation documents). For example, the presentation service 208 may receive instructions to generate a presentation from a user-generated document, extract user-generated content from the user-generated document, and generate a set of candidate presentation segments using a generative output system 224. For example, the presentation service 208 may generate a presentation generation prompt that includes query prompt text, the extracted user-generated content from the user-generated document, and a natural-language input from a user that specifies an intent for the presentation (e.g., a description of what the presentation is for). The presentation service 208 may provide the presentation generation prompt to a generative output engine, and receive a set of candidate presentation segments that are based on the underlying document and that conform to the user's intent for the presentation (and optionally other constraints, properties, parameters, etc.). The presentation service 208 may accept changes and/or modifications to the candidate presentation segments, and may ultimately generate a presentation document that includes the candidate presentation segments.

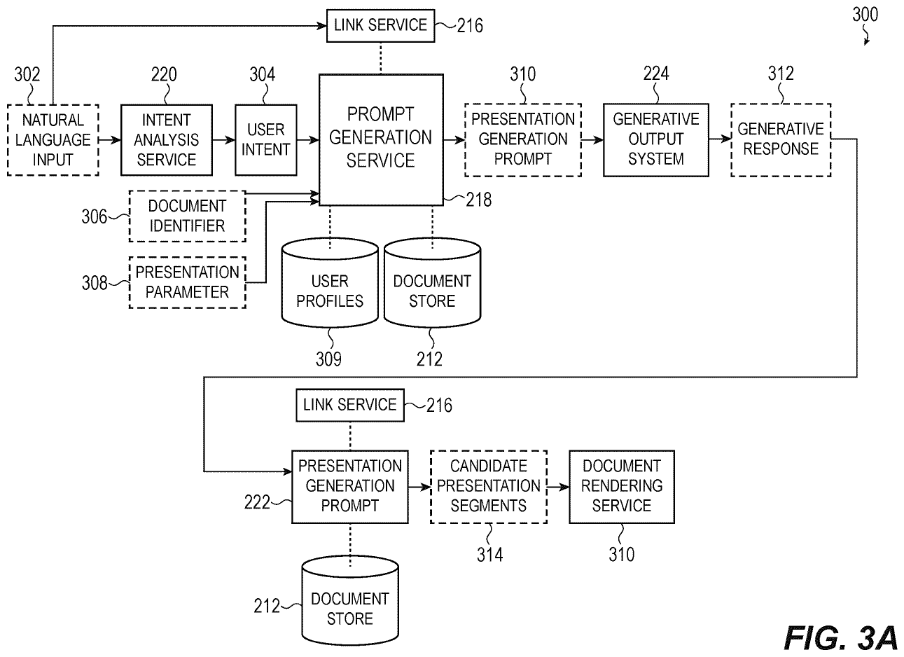

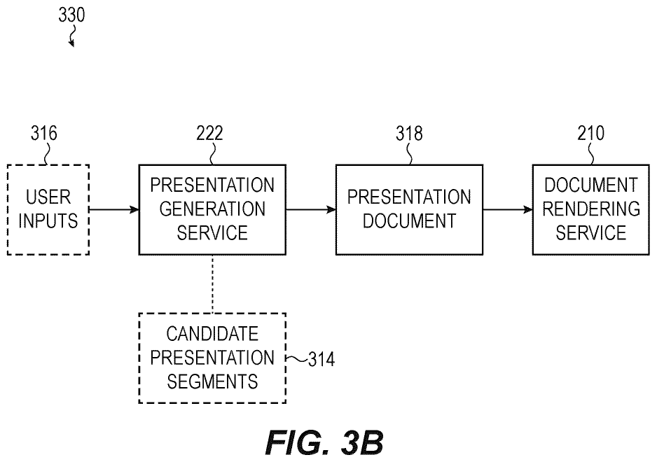

The functions of the presentation service 208 may be performed by one or more services, including a user input service 214, a link service 216, a prompt generation service 218, an intent analysis service 220, and a presentation generation service 222. The functions of these services are described in greater detail with respect to FIGS. 3A-3B. Any of these services may use or communicate with the generative output system 224 to facilitate its functionality. The generative output system 224 may correspond to the generative output service 116, the central generative service 112, and/or other combinations of the generative output service 116 and other services that support the functionality of the generative output service 116.

FIGS. 3A-3B illustrate an example operation 300 of the presentation service 208. The operation 300 may be initiated by a user requesting, via a graphical user interface of the document platform 206, to generate a presentation document based on a user-generated document of the document platform 206 (or multiple user-generated documents). The request may be made with respect to a particular user-generated document, which may be associated with an identifier 306 that identifies the user-generated document (e.g., within the document store 212 of the document platform 206). The request may also be made with respect to multiple user-generated documents (and/or other documents or content sources).

In response to the request, the document platform 206 may display a presentation generation selection window in the graphical user interface of the document platform 206, where the presentation generation selection window accepts inputs that specify the user's intent for the presentation document. For example, the presentation generation selection window may include a text input field for receiving a natural language input 302 from the user. The natural language input may include a natural language description of the presentation document. In some cases, the user may be prompted to provide particular types of information in the natural language input, such as an intended audience of the presentation, a goal of the presentation, a target length or complexity of the presentation, or the like. Since the natural language input may be analyzed to determine a user intent parameter for the presentation (and/or may be provided to a generative output system), the natural language input need not be in any particular format, nor must it contain any particular information. More particularly, an intent analysis operation and/or the generative output system may be configured to operate on and/or be responsive to any natural language input. As a specific example, the presentation service 208 may be responsive to inputs as simple as “make a presentation” and also to inputs as detailed as “produce a technical summary presentation with between 5 and 7 sections, each section having a heading and no more than 100 words, for an audience of highly trained computer engineers.” Regardless of the level of detail or particular information provided, the presentation service 208 may be responsive to the input.

As described herein, in some cases, a natural language input, or a portion thereof, may be provided to the prompt generation service 218 of the presentation service 208, and the prompt generation service 218 may create a presentation generation prompt that includes the natural language input (or a portion thereof). In some cases, instead of or in addition to providing the natural language input 302 to the prompt generation service 218, the natural language input is analyzed to determine a user intent parameter for the presentation. For example, the natural language input 302 may be provided to the intent analysis service 220 of the presentation service 208. The intent analysis service 220 may be use the generative output system 224 to determine a user intent parameter. For example, the intent analysis service 220 may generate an intent request prompt that includes predetermined query prompt text and the natural language input (or a portion thereof). The predetermined query prompt text may request that the generative output system 224 identify and return any constraints, properties, descriptions, or other relevant information that may be used to influence the content, appearance or other property of the presentation document. In response to the intent request prompt, the generative output system 224 may return a user intent 304. The user intent 304 may include one or more simplified, normalized, or interpreted statements of the user intent for the presentation. For example, for a natural language input of “make a short and sweet presentation for the finance guys,” the user intent 304 (as generated by the intent analysis service 220 optionally with the generative output system 224) may include specifications such as “presentation length: short; presentation complexity: simple; presentation subject: financial information; presentation audience: financial services.” These are merely examples, and any other specifications or representations of the user's intent may be generated.

In some cases, the intent analysis service 220 may determine a user intent parameter for a natural language input by selecting or attempting to fit the natural language input to one or more of a set of predetermined user intent parameters. For example, the intent analysis service 220 may be configured to identify values of a predetermined set of user intent parameters, such as presentation length, presentation complexity, presentation audience, presentation subject, or the like. In some cases, the predefined set of user intent parameters may have a set of predetermined candidate values (e.g., length: long, medium, short; complexity: high, medium, low; audience: superiors, peers; etc.), and the intent analysis service 220 may determine which, if any, predetermined value is indicated by the natural language input. In some cases, the intent analysis service 220 (optionally using the generative output system 224) may apply a confidence value to each of the possible user intent parameters and/or parameter values, and may generate a user intent 304 for any parameters and/or values that satisfy an intent condition (e.g., a confidence value greater than 0.7 on a scale from 0 to 1, or any other suitable condition or threshold).

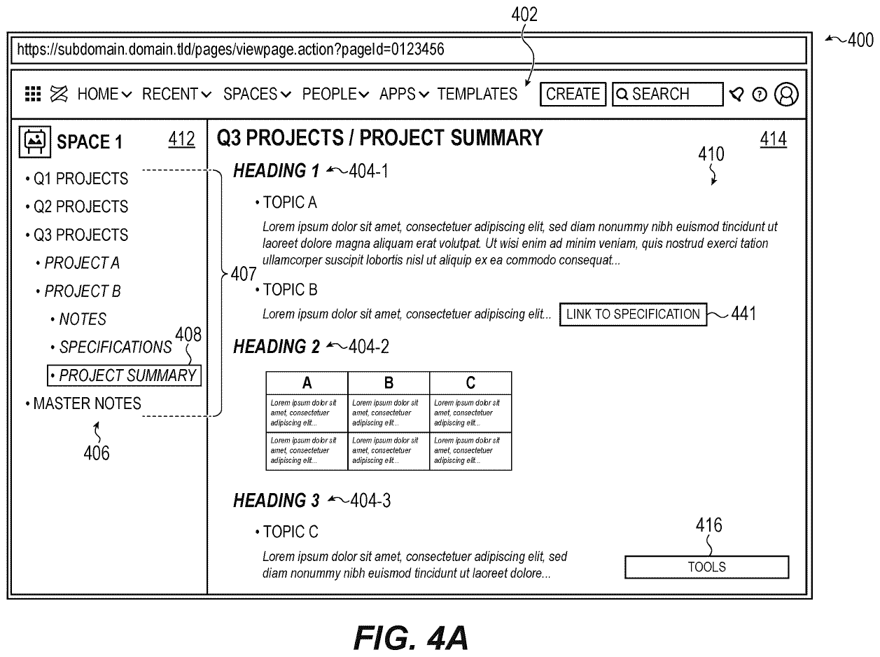

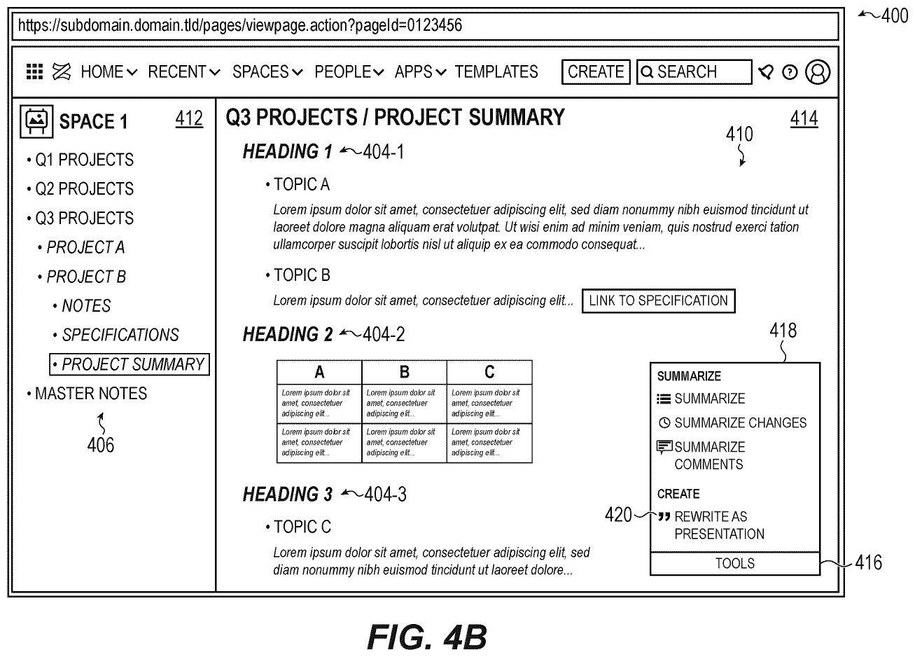

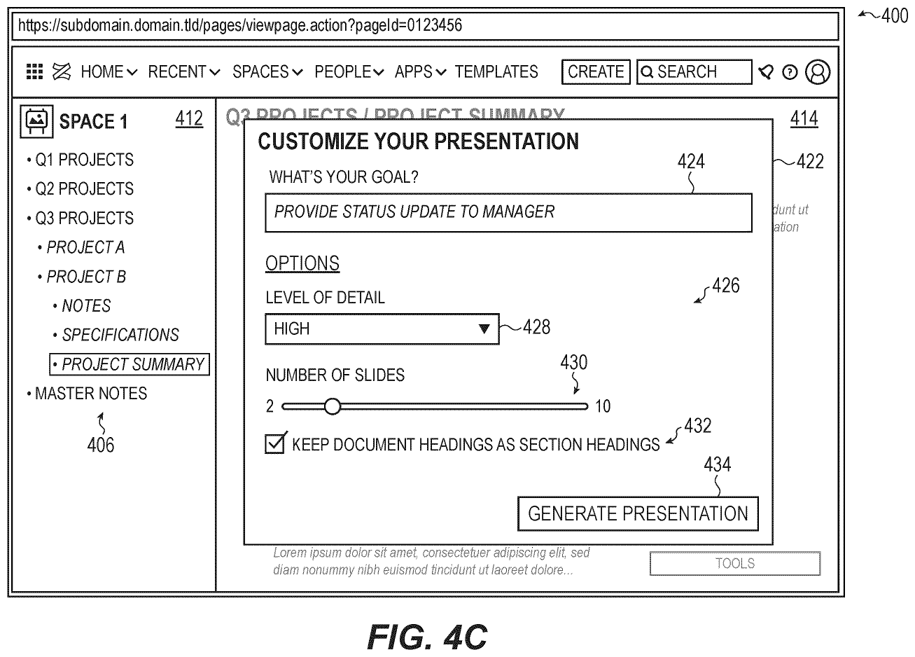

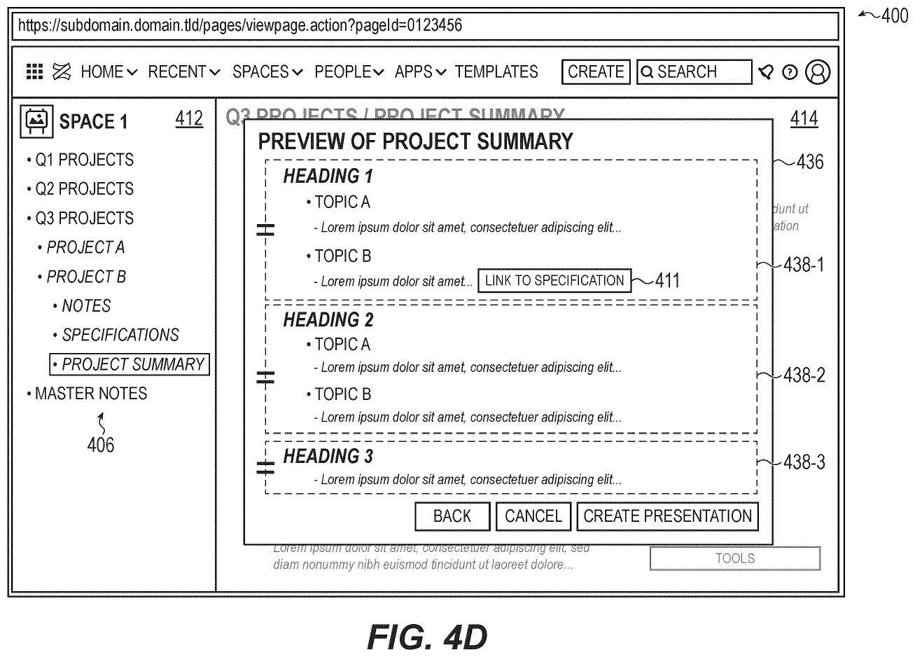

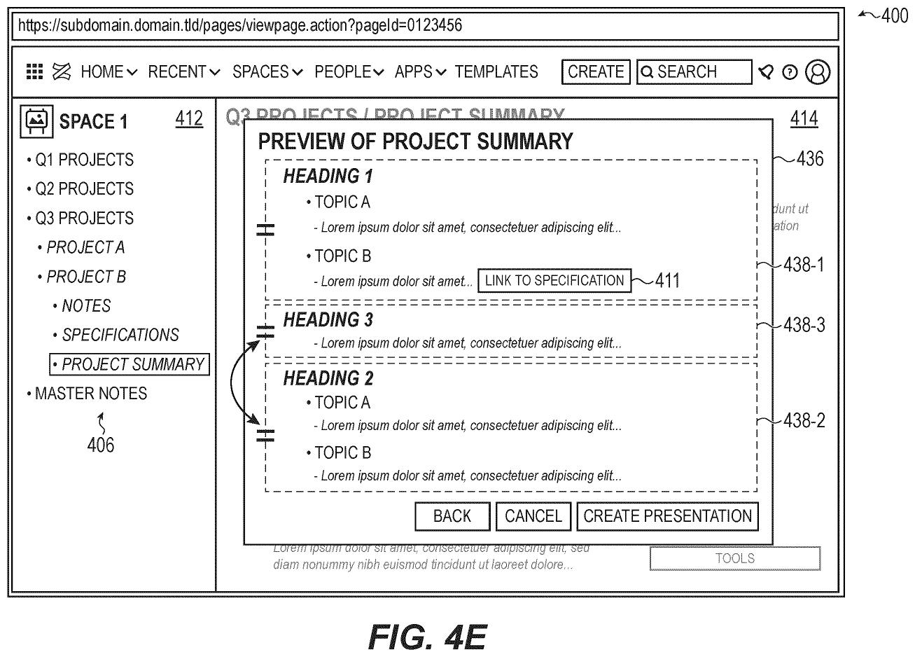

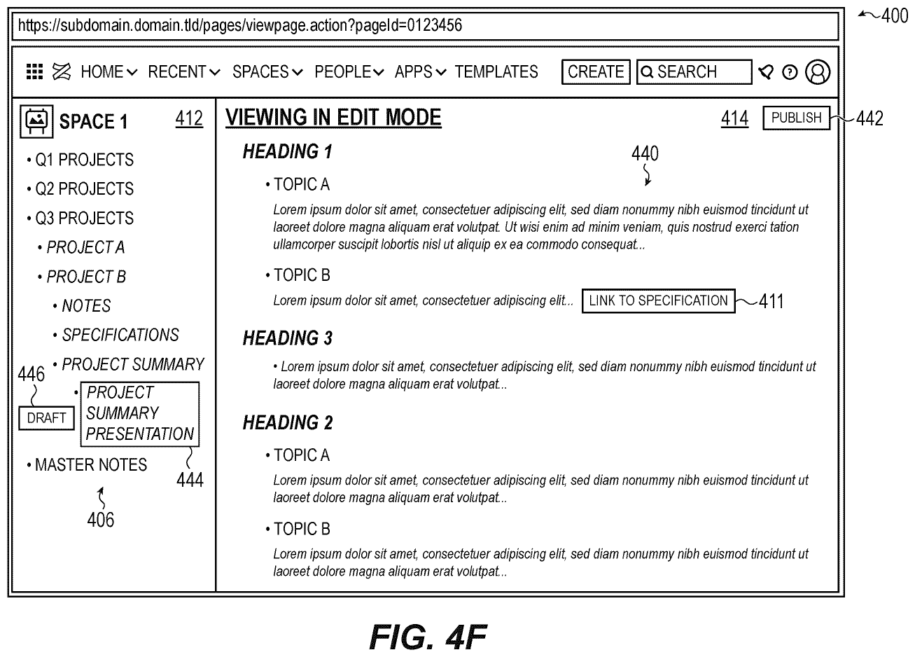

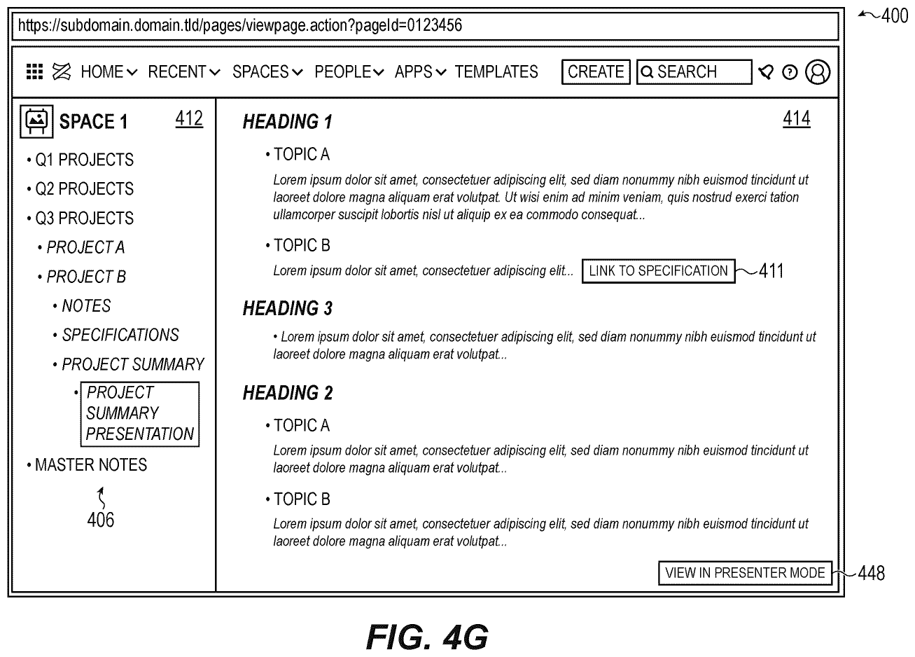

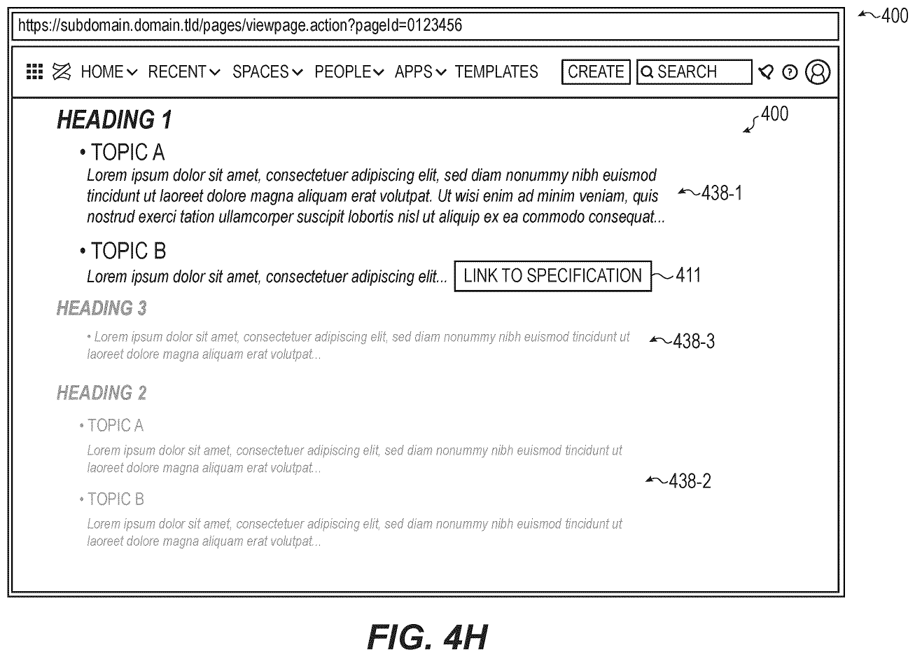

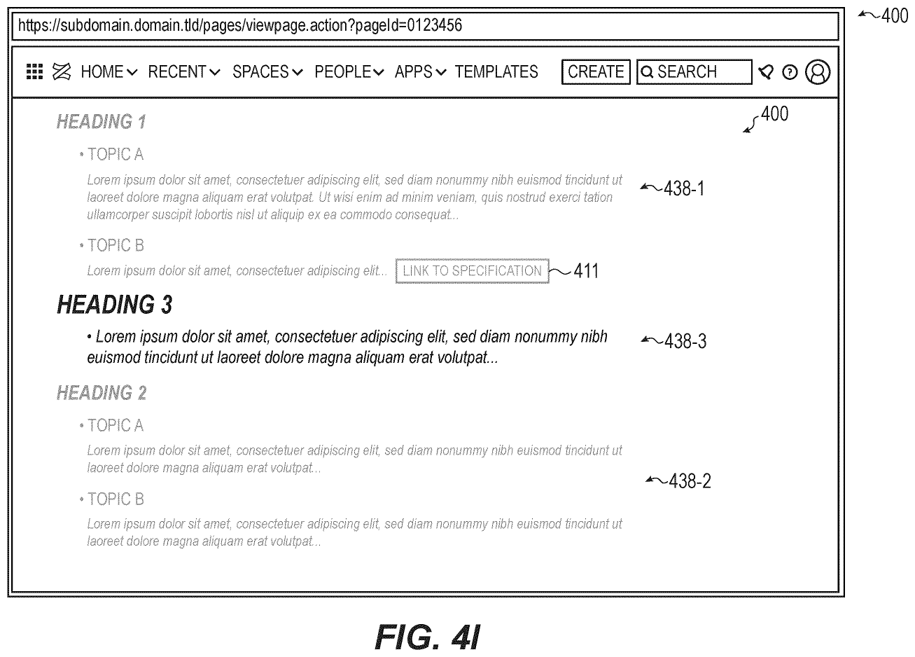

The presentation generation selection window may further include one or more presentation parameter selection elements for receiving user selections of presentation parameters 308. The presentation parameter selection elements may include options to select or specify various different parameters for the presentation document that is to be generated. For example, the presentation parameter selection elements may be used to specify parameters such as presentation length, presentation content complexity, number of presentation segments and/or slides, presentation organization, how to manage certain types of content in the underlying user-generated documents, or the like. As one example, the presentation parameter selection elements may be used to specify how to map content headings in an underlying document to presentation segments in the presentation document. The presentation parameter selection elements may include text input fields, sliders elements, radio buttons, selection boxes, or other graphical elements for selecting parameters and/or parameter values. Examples of a presentation generation selection window and example presentation parameter selection elements are provided herein, such as in FIG. 4C.

Ultimately, the instruction to generate a presentation from the user-generated document may include the document identifier 306, the optional user intent 304, the natural language input 302, and the presentation parameter(s) 308, each of which may be provided to the prompt generation service 218 to generate a presentation generation prompt 310. As described herein, the presentation generation prompt 310 is provided to the generative output system 224 in order to generate a set of candidate presentation segments that will ultimately be incorporated into a draft of a presentation document.

The prompt generation service 218 may receive the instruction to generate the presentation, including receiving the document identifier 306, the optional user intent 304, the natural language input 302, and the presentation parameter(s) 308. In response to the instruction, the prompt generation service 218 may generate a presentation generation prompt 310 for submission to the generative output system 224.

The presentation generation prompt 310 may include various components or information. For example, the presentation generation prompt 310 may include predetermined query prompt text. The predetermined query prompt text may request the generative output system 224 to provide a particular type of output, and may specify certain parameters or instructions for the generative output system 224. For example, the predetermined query prompt text may specify that the generative output system 224 should return a set of presentation segments that are based on user-generated content that is included in the prompt, and which has a particular format (e.g., logically delimited segments so that each segment can be separately identified, etc.).

The presentation generation prompt 310 may also include user-generated content that is extracted from the user-generated document (or documents) from which the presentation is to be generated. More particularly, the prompt generation service 218 may retrieve or access the user-generated document that is identified by the document identifier 306 (e.g., by accessing the document in the document store 212 of the document platform 206), and may extract user-generated content from the document. The extracted user-generated content may be provided as the source material that the generative output system 224 may use to generate the presentation segments. The extracted user-generated content may include text content from the user-generated document. In some cases, the extracted user-generated content may also include textual content that defines references to and/or identifiers of non-textual content, such as links, addresses, and/or other identifiers of images, videos, audio, tables, charts, or any other content that is embedded in and/or referenced by the user-generated document. In some cases, the predetermined query prompt text for the prompt may include instructions for the generative output system that specify how such content is to be handled (e.g., instructing the generative service to keep the same textual references unchanged in the generative output). In this way, the generative output, which may include presentation segments that are ultimately incorporated into a presentation document, may include the same or similar embedded, non-textual content as the underlying source document.

The presentation generation prompt 310 may also include the user intent parameter 304 for the presentation (e.g., as determined by the intent analysis service 220), and optionally at least a portion of the natural language input 302. These portions of the prompt 310 may be provided in order to constrain or otherwise guide the output of the generative output system 224, and more particularly, so that the presentation that is ultimately generated meets the user's specifications.

As described herein, the presentation service 208 may be configured to retain certain types of platform-specific content from the underlying document, such as selectable graphical objects. The selectable graphical objects may refer to another content item (e.g., another user-generated document, a website, a knowledge base document, etc.), and may, when selected and/or rendered, cause the graphical user interface of the document platform to be redirected to the content item viewed in a native platform for that content item. A selectable graphical object may include metadata and other content extracted from the referenced content item, and may cause the graphical user interface to render the extracted content in a panel, card or other graphical element of the selectable graphical object. Selectable graphical objects may correspond to or be defined by data structures that are incorporated into a document, and the link service 216 is configured to identify such data structures and generate the presentation generation prompt 310 in order to preserve such data structures in the generative output, such that the data structures and ultimately the selectable graphical objects that they produce are included in the presentation document that is ultimately generated.

The link service 216 may be configured to identify data structures in user-generated documents and generate the presentation generation prompt 310 in a manner that results in preserving the data structures through the generative processing operations and ultimately incorporate the selectable graphical objects in the presentation document. For example, the link service 216 may identify, in the user-generated document(s) identified by the document identifier(s) 306, a data structure referencing a separate document (e.g., a data structure corresponding to a selectable graphical object). The link service 216 may generate a unique identifier for the data structure, and include the unique identifier in the presentation generation prompt 310. For example, the unique identifier may be included in the extracted content from the user-generated document(s) in place of (and/or in association with) the data structure. The link service 216 may also store the data structure (e.g., a copy of the data structure) in association with the unique identifier, such that the link service 216 can later repopulate presentation document content with the data structure.

In some cases, the predetermined query prompt that is included in the presentation generation prompt 310 may include instructions on how the generative output system 224 should handle the unique identifier and the data structure. For example, the prompt 310 may include instructions that the unique identifier and the data structure should be incorporated, unchanged, in any generative output. In some cases, the prompt 310 may include instructions that the generative output system 224 should ignore the unique identifier and/or the data structure for the purposes of analyzing the extracted content. As described herein, the data structures may reference other content items, such as remote documents. In such cases, the link service 216 and/or the prompt generation service 218 may extract content from the identified documents or content items and incorporate the content into the presentation generation prompt 310, such that the linked content may ultimately be incorporated into or referenced in the presentation document that is ultimately generated. The presentation service 208 may also use the link service 216 to repopulate candidate presentation segments that include the unique identifiers with corresponding data structures.

The presentation generation prompt 310 may also include information that can be used to guide the generative output system 224 with respect to the tone and/or style of the presentation content that is to be generated. For example, the prompt generation service 218 may extract a user content sample from at least one other document generated by a user, and include the extracted user content sample in the presentation generation prompt 310. The prompt generation service 218 may include an instruction in the presentation generation prompt 310 that the style and/or tone of the presentation content that is generated (e.g., the candidate presentation segments) should have a tone and/or style that matches or is consistent with that of the user content sample.

The presentation generation prompt 310 may also include information about the user who initiated the request to generate a presentation, which may be used to guide the generative output system 224 with respect to the presentation content that is to be generated. For example, the prompt generation service 218 may access a user profile, in a user profile data store 309, to extract and/or identify information about the user. The information may include, without limitation, a role of the user, a job title of the user, a team or project affiliation of the user, an experience level of the user, a relationship of the user to other users and/or the intended audience of the presentation, and the like. As one example, the prompt generation service 218 may determine that the requesting user has requested a presentation whose audience will be the user's supervisor. This information may be incorporated in the presentation generation prompt 310 with an instruction that the presentation should have a tone, style, and content that is appropriate for a presentation to the user's supervisor. The user profile data store 309 may be a user profile data store that is associated with the document platform 206 (e.g., containing user profile information for users of the document platform 206), or any for other software platforms and/or services that are serviced by the presentation service 208.

Returning to FIG. 3A, the prompt generation service outputs a presentation generation prompt 310. The presentation generation prompt 310 may be provided, as input, to the generative output system 224. The generative output system 224 then generates a generative response 312 based on the presentation generation prompt 310. The generative response 312 may include textual content that generally corresponds to and/or can be used to generate candidate presentation segments.

The presentation generation service 222 may receive the generative response 312 and generate a set of candidate presentation segments 314 based on the generative response 312. To generate the candidate presentation segments 314, the presentation generation service 222 may apply formatting to the generative response or otherwise prepare the content of the generative response 312 for presentation to the user. In some cases, generating the candidate presentation segments may include applying formatting to the content, converting the generative response 312 to a different data format (e.g., to a platform-specific markup language), adding markup to delineate between different segments, or the like.

In some cases, generating the set of candidate presentation segments 314 includes repopulating candidate presentation segments with data structures (e.g., of selectable graphical objects) that were identified in the source document by the link service 216. For example, the link service 216 may identify any unique identifiers in the generative response 312, and repopulate the generative response 312 with the data structure that corresponds to the unique identifier (e.g., which was saved by the link service 216). In examples where the data structure itself was in the presentation generation prompt 310 and is also included in the generative response 312, the link service 216 may check the data structure against the stored data structure to ensure that it is identical (e.g., that the generative output system 224 did not alter the data structure). The link service 216 may make any necessary corrections to the data structure, and ultimately incorporate the data structure into the generative response when generating the candidate presentation segments 314. The presentation generation service 222 and/or the link service 216 may also remove any of the previously incorporated unique identifiers from the generative response when generating the candidate presentation segments 314.

The generative response 312 need not include all of the unique identifiers and/or data structures of the source document. In particular, the generative output system 224 may choose to include or exclude a data structure from the generative response 312. However, any data structures (and their corresponding unique identifiers) that are incorporated in the generative response 312 may be processed by the link service 216 so that the selectable graphical objects that they define are properly rendered in the presentation document that is generated.

Once the candidate presentation segments 314 are generated, they may be rendered by a document rendering service 210 in a graphical user interface of the client application for review by a user. For example, as described herein, the candidate presentation segments 314 may be displayed in a presentation preview window of the graphical user interface, allowing the user to review, reorder, and/or modify the candidate presentation segments 314 prior to generating the presentation document.

FIG. 3B illustrates an example operation 330 for displaying the candidate presentation segments 314 and generating a presentation document 318 based on the presentation segments. In particular, while the candidate presentation segments 314 are rendered in the presentation preview window, the user may provide user inputs 316 that correspond to modifications to the candidate presentation segments 314 and/or the order of the segments. For example, a user may modify the content of one or more candidate presentation segments 314 within the presentation preview window, or they may reorder the segments (e.g., by dragging the segments to desired positions in the presentation preview window). The presentation generation service 222 may receive the user inputs 316 and incorporate any changes or modifications indicated by the inputs, and generate the presentation document 318 including the modified and/or reordered presentation segments. The presentation document 318 may then be stored in association with the document platform 206 (e.g., in the document store 212) and rendered in the graphical user interface of the client application by the document rendering service 210. In some cases, as described herein, the presentation document 318 may be initially displayed in an edit mode, in which the user can make further modifications or changes to the presentation document 318. The user may save and/or publish the presentation document 318, which may allow the presentation document to be viewed by others, or otherwise close or terminate an editing session with the presentation document.

In some cases, the presentation document may be formatted as a continuous document that includes separate presentation segments. The document rendering service 210 may be configured to render this document in various manners. For example, the document rendering service 210 may in some cases render the presentation document in a non-paginated view mode providing continuous scrolling of the presentation document, and in other cases, render the presentation document in a content toggling view mode. The content toggling view mode may include the content of the presentation document displayed in a full-screen pane configured to provide toggle-based navigation in which a user input causes an automatic advance of the content of the presentation document to a respective presentation segment identified within the content of the presentation document. For example, in the content toggling view mode, a user can advance to a next (or previous) presentation segment with an input. As described herein, advancing to a next presentation segment may include displaying the next presentation segment in an emphasized or more visible manner, while displaying the previous presentation segment in a deemphasized or less visible manner. In this way, the presentation segments may be sequentially displayed in a visually distinct manner, thus facilitating a segment-by-segment presentation experience of the presentation document.

In some cases, instead of or in addition to generating a presentation document with a continuous (e.g., non-paginated) format, a presentation document includes a set of distinct slides. In such cases, each presentation segment may be formatted as and/or included in a slide. In particular, the presentation generation service may generate a respective presentation slide for each respective presentation segment of the presentation document (and/or of the set of candidate presentation segments 314).

FIGS. 3A-3B provide examples of services that may perform the various functions of the operation 300. However, it will be understood that these are merely examples of mappings between functions and services, and other mappings may also implement the same operation or produce the same outcomes. In other example implementations, services may be combined or separated, or different services may provide the functions ascribed to a particular service. It will be understood that the services described herein need not be separately identifiable software programs, modules, applications, or other distinguishable program elements or functions. Rather, the services are intended to describe the various functions provided by the presentation service and illustrate an example operational flow for generating a presentation document, as described herein.

FIGS. 4A-4I illustrate example graphical user interfaces that may be displayed to a user during (and to facilitate) generation of presentation documents. For example, the user may access a system (e.g., a system that incorporates or accesses presentation generation functionality of the presentation service 208) using a platform frontend application, which may be operating on the hardware of a client device (e.g., a client device 104), also referred to as a platform frontend. The platform application of the platform frontend may include a browser or other web-enabled application that is adapted for use with a web-based platform backend or other similar service over a computer network like the web or internet. In other examples, the platform application of the platform frontend is a dedicated client application that is adapted to communicate with a dedicated backend or other server system via a computer network. As described herein, a system may include platform backends, which may be either web-based servers or dedicated backend servers, depending on the implementation. The frontend application of the platform frontend provides a graphical user interface for the platform, such as the graphical user interface 400, which may include content creation interfaces, content viewing interfaces, and other interfaces for interacting with the content and features of the platform backend.

The GUI 400 may be a GUI of a document platform (e.g., the document platform 206), an issue tracking platform, a codebase platform, or the like, and may include or instantiate a GUI or GUI elements of a presentation service, as described herein. In some cases, the GUI 400 provides access to and/or instantiates GUIs of multiple different software platforms. It will be understood that these are merely exemplary, and more, fewer, or different selectable elements may be included in a GUI 400.

The graphical user interface 400 includes a content region 414 also referred to as a content panel, which displays the content of a respective electronic document 410 (including presentation documents). The document 410 (or content of the document) may include text content, selectable graphical objects, rich text content, images, videos, and other content. The content region 414 may include or operate an editor that is configured to receive user-generated content, which is used to generate or modify the content of the document. As shown in FIG. 4A, the user-generated content may include what is referred to as structured rich text content, which may be formatted in accordance with a formatting scheme, such as HTML, XML, Atlassian Document Format (ADF), or other similar scheme or language. The particular schema may also be referred to as a platform-specific or editor-specific formatting schema. In some examples, the text content can also be displayed in line with hypertext, graphical elements and other content that is enabled by the editor instantiated by the frontend application within the content region 414.

The graphical user interface 400 also includes a navigational region 412, also referred to as a navigational panel, which includes a set of selectable elements 407 that are selectable to cause display of respective content items or navigate to other aspects of a document space. In this example, the navigational region 412 includes a hierarchical element tree 406 also referred to as a content tree or a page tree, which includes an array of selectable tree elements 407 that are hierarchically arranged in accordance with parent-child relationships between respective documents of the document space. The elements 407 may include a short title and/or graphical elements that indicate the subject matter and type of content item associated with each respective element. Elements 407 may also be selected and moved within the content tree 406 in order to redefine a parent-child relationship between the respective elements. The collection of elements depicted in the navigational region 412 may be associated with a respective space, also referred to herein as a content space, page space, or document space. A space defines a collection of content items for which the space creator is the default administrator having default read, write, view, and control permissions with respect to all items within the space. Content and navigational regions 414, 412 may also be referred to herein as “panes,” “panels,” or “areas” of the graphical user interface 400.

The graphical user interface 400 also includes a control bar 402 that includes an array of selectable controls for navigating to different spaces, documents, applications, or modules. Generally, the graphical user interface 400 provided by the frontend or client application may operate in one of a number of different modes. In a first mode, a user may create, edit or modify documents or other digital content. This mode or state of the graphical user interface 400 may be referred to as an editor user interface, content-edit user interface, a document-edit user interface, or document-edit user interface. In a second or other mode, the user may view, search, comment on, or share the electronic document, or digital content. This mode or state of the graphical user interface may be referred to as a viewer user interface, content-view user interface, a document-view user interface, or document-view user interface. The graphical user interface may be implemented in a web browser client application using HTML, JavaScript, or other web-enabled protocol.

The graphical user interface 400 may allow the user to create, edit, or otherwise modify user-generated content that is stored as an electronic document. The electronic document or other digital content may be rendered on a client device by the content collaboration service upon authorization/authentication of the user by the authentication/authorization service, and based on permissions granted to the user as validated according to a user profile associated with the user. Further, the content that is rendered in the content region 414 may contain content extracted from or obtained from other content items having their own respective permissions profiles.

With reference to FIG. 4A, the content region 414 is displaying a user-generated document 410, corresponding to selectable element 408 in the content tree 406. The user-generated document 410 includes user-generated content. In some cases, the user-generated content includes content headings 404 (e.g., 404-1, 404-2, 404-3), though content headings are not required. The content headings may be user-generated, and may generally identify a segment or section of the document 410 that pertains to a particular topic or subject. The user-generated document 410 may include various types of content, including text, images, videos, audio, tables, charts, graphs, or other types of content. The user-generated document 410 may also include a selectable graphical object 411, which is defined by a data structure, as described herein.

The user-generated document 410 may serve the basis for an automatically generated presentation document, as described herein. For example, the GUI 400 may include a tools element 416. Upon selection of the tools element 416, the user may access a tool menu 418 (FIG. 4B), which includes an option 420 to generate a presentation from the currently displayed document (e.g., “rewrite as presentation”). While FIG. 4B illustrates the tool element 416 associated with the displayed document, the option to generate a presentation from a user-generated document may also be available for documents that are not currently displayed in the content region 414. Selecting the option 420 may initiate the operation 300 of generating a presentation document for the selected user-generated document 410. Further, while FIGS. 4A-4I illustrate an example in which a presentation document is generated from a single user-generated document, a presentation document may similarly be generated from multiple user-generated documents. For example, a user may select multiple documents from the content tree 406 (or via another user interface element), and the presentation generation operation may use all of the selected documents as source material for the presentation.

With reference to FIG. 4C, upon selection of the option 420, a presentation generation selection window 422 may be displayed in the GUI 400. The presentation generation selection window 422 may include user interface objects that allow the user to specify various parameters and constraints for the presentation generation operation, as well as provide a natural language input that generally describes, in plain language, the goal, purpose, or other general description of the presentation. For example, the presentation generation selection window 422 may include a text input field 424, which may be associated with a prompt asking the user for a goal, purpose, or other description of the presentation. The natural language input provided in the text input field 424 may be provided to the presentation service 208 (e.g., as the natural language input 302, FIG. 3A). As described above, the natural language input may be analyzed to determine a user intent for the presentation, and may be included (at least in part) in the presentation generation prompt.

The presentation generation selection window 422 may also include one or more presentation parameter selection elements 426 for receiving a user selection of a presentation parameter. The presentation parameter selection elements 426 may allow the user to select certain predetermined presentation parameters to apply to the presentation generation process. For example, the presentation parameter selection elements may include a detail level selection element 428, a slide count selection element 430, and a heading preservation selection element 432. The presentation generation selection window 422 may also include a generate presentation element 434 that initiates generation of a presentation document according to the options and inputs provided in the presentation generation selection window 422.

The detail level selection element 428 allows a user to select a level of detail to be included in the presentation document. The detail level selection element 428 may be a dropdown selection element with a set of prepopulated detail level options, such as high, medium, and low (or any other prepopulated options). The selected detail level may be included in the presentation generation prompt 310 that informs the generative output system 224 of the level of detail to include in the presentation document. In some cases, the user may also specify a detail level in the natural language input. To the extent that the instructions conflict (e.g., specify different detail levels), the presentation service 208 may default to the detail level specification in the natural language input.

The slide count selection element 430 allows a user to specify a number of presentation segments (or slides) to be included in the presentation document. In some cases, presentation segments correspond to slides, such that the user selection applies to both the number of presentation segments generated and the number of slides generated. The slide count selection element 430 may be constrained to a maximum and minimum number of presentation segments, and the constraint may be generated based on the user-generated document that is the basis of the presentation, and/or the natural language input. For example, the size, length, information content, or other content property of the source user-generated document may dictate or influence the minimum and maximum number of presentation segments that are needed or can be used to summarize the content. For example, a one-page user-generated document may not be amenable to a 100-slide presentation. Thus, the presentation service 208 may determine a set of constraints for the slide count selection element 430 based on the length (or other property) of the source user-generated document. In some cases, the constraints may include a minimum number of presentation segments and a maximum number of presentation segments. The maximum and minimum number of presentation segments may be determined in various ways. For example, the minimum number of presentation segments may be generated by analyzing the user-generated document (e.g., with the generative output system 224) to identify a set of main or principal subjects described in the document, and the minimum number of presentation segments may be established as the number of main or principal subjects. The maximum number of presentation segments may be set as the number of content headings in the document (e.g., one presentation segment per content heading). Other techniques may also be used to select the slide count constraints.

As another option, the slide count constraints, as well as constraints on any other presentation parameter, may be determined from the natural language input. For example, upon receiving a natural language input in the text input field 424, the presentation service 208 may determine (e.g., using the generative output system 224) whether the natural language input includes any information that pertain to or would suggest a limitation on the range of constraints that the user may select. Thus, for example, if the natural language input includes the statement “make a short presentation for my boss,” the presentation service 208 may select a range of potential presentation segments that reflects the desire for a short presentation (e.g., a range of 5-10 segments). Similarly, if the natural language input includes the statement “make a simple presentation for my team members,” the presentation service 208 may omit a “high” detail level option from the detail level selection element 428. These are merely examples, however, and the presentation service 208 may modify the available presentation parameter values (and optionally select what presentation parameter selection elements are displayed) based on the natural language input and/or the source user-generated document.

The heading preservation selection element 432 allows a user to specify that the presentation document should create a distinct presentation segment and/or slide for each distinct content heading in the document. For example, with respect to FIG. 4B, the user-generated document 410 includes content headings 404-1, 404-2, 404-3, which are user-generated content headings. Selecting to preserve each content heading as a presentation segment heading will result in each content heading 404 corresponding to at least one unique presentation segment. In some cases, the selection to preserve each content heading as a presentation segment may result in a constraint to include only one presentation segment for each content heading (e.g., forcing the generative output system 224 to generate single-segment summaries for each content heading). In other cases, the selection to preserve each content heading as a presentation segment may result in a constraint to include at least one presentation segment for each content heading (e.g., allowing the generative output system 224 to generate multiple presentation segments for each content heading).

Once the user has provided their desired inputs to the presentation generation selection window 422, the user may select the generate presentation element 434. In response to the selection, the presentation service 208 may initiate the operation 300 to generate a set of candidate presentation segments that correspond to the inputs. As described herein, the presentation service 208 may be provided with the natural language input provided in the text input field 424, a document identifier identifying the selected user-generated document 408, and presentation parameters, including parameters specified by the user selection sin the presentation generation selection window 422.

FIG. 4D illustrates the GUI 400 displaying a presentation preview window 436. The presentation preview window 436 displays presentation segments 438 generated by the generative output system 224. (The presentation segments 438 may correspond to the presentation segments 314 in FIG. 3A.) In this example, each respective presentation segment corresponds to a respective content heading in the user-generated document 410, though this is not necessarily the case (e.g., depending on user specifications and other factors).

In some cases, the display of the presentation segments 438 is shown in real-time, as the presentation segments are produced by the generative output system 224 (e.g., including showing the text populating in a sequential fashion). The presentation segments 438 may be shown in an order that corresponds to the order of the content in the source user-generated document. Also, FIG. 4D illustrates the presentation segment 438-1 with the selectable graphical object 411, which was preserved from the corresponding content portion of the source user-generated document 410. As described herein, the selectable graphical object 411 may be incorporated into the presentation segment 438-1 with the link service 216.

As described herein, the presentation preview window 436 affords the user an opportunity to modify the order and/or the content of the candidate presentation segments 438 before the presentation document is generated. For example, FIG. 4E illustrates a user change in the order of the presentation segments 438. In particular, the presentation preview window 436 may facilitate dragging and dropping presentation segments to change their order in the presentation document. Other edits or change may also be performed in the presentation preview window 436. For example, a user may modify the content of the presentation segments 438 (e.g., changing, adding, or removing text, images, charts, links, selectable graphical objects, and the like). Once the user has made any desired modifications to the presentation segments 438 and/or the order of the presentation segments 438, the user may initiate the generation of a presentation document (e.g., by selecting a “create presentation” element in the presentation preview window 436), which causes the presentation service 208 to generate the presentation document. Initiating the generation of the presentation document may correspond to an acceptance, by the user, of the presentation segments (as optionally modified by the user).

With reference to FIG. 4F, upon generation of the presentation document, the presentation document 440 may be displayed in the content pane 414 in an edit or unpublished mode. Further, a selectable element 444 representing (and linking to) the presentation document 440 may be displayed in the content tree 406, at a location that reflects a hierarchical relationship between the presentation document 440 and the user-generated document 410. For example, the selectable element 444 may be shown as a child document of the user-generated document 410 from which the presentation document 440 was generated. In other examples, the selectable element 444 may be shown as a peer document of the user-generated document (e.g., in the same level of the hierarchy reflected in the content tree 406). Additionally, the edit mode or unpublished status of the presentation document 440 may be reflected in the content tree 406 by a “draft” indicator 446. In the draft state, the presentation document 440 may only be viewable by the user who created the presentation document 440, and the presentation document 440 may be available for editing.

As shown in FIG. 4F, the presentation document 440 may be presented (e.g., prior to displaying the presentation document in a presentation mode) for editing by the user. In this mode, the user may make any edits to the presentation document 440 that are supported by the document platform 206, including adding, changing, or removing text, images, videos, audio, charts, graphs, links, selectable graphical objects, formatting, and the like. Notably, the presentation segments may not be constrained or otherwise subject to any limitations on editing. Accordingly, the user can fully customize the presentation document 440 to their preferences.

FIG. 4G illustrates the GUI 400 after the user has published the presentation document 440. As shown, the presentation document 440 is displayed in the content pane 414, and the draft indicator 446 is no longer shown in the content tree 406. When displayed in the content pane 414, the presentation document 440 may be displayed in a non-paginated view mode that provides continuous scrolling of the presentation document 440. In this mode, the presentation segments of the presentation document 440 may not be visually or otherwise distinguished from one another.

In some cases, the GUI 400 also provides another document view mode, such as a synchronous view mode that may be adapted for group viewing using a shared screen, videoconference, or other similar electronic communication tool. The synchronous view mode may present the content in an interface that is adapted for what is referred to herein as toggle-based scrolling or topic-based scrolling. This mode may also be referred to herein as a toggling view mode or continuously paginated view mode in which the content may be advanced in accordance with a set of topic portions (e.g., presentation segments) in the content. In response to a user input, such as the arrow keys on a keyboard, the document may be scrolled in increments that are defined by respective topic portions. However, in contrast with a hard paginated document defining regular or uniform page breaks, the toggle-based scrolling allows for navigation that is tailored to the content of the presentation document rather than to a predefined page size or scroll distance. Further, as described herein, the presentation segments may be emphasized with respect to other content being contemporaneously displayed in the interface. For example, the topic portion may have an increased size, increased darkness, or other visually distinct characteristic, as compared to the other content being displayed. By way of further example, the other content being displayed may be de-emphasized by being muted, ghosted, have a darkness that is reduced as compared to the current topic portion, or otherwise provide for a visual distinction that emphasizes the current topic portion.

In accordance with some embodiments described herein, the synchronous view mode (also referred to as a toggling view mode or continuously paginated view mode) may be presented in a full-screen pane 450 in which the content of the current presentation document is displayed over a substantial entirety of a view area defined by the GUI 400. In some cases, the full-screen pane extends across a substantial entirety of the display of a particular client device or an available view port, as defined by a screen share service, video conference service, or other electronic communication tool.

Further, the synchronous view mode or continuously paginated view mode may omit or suppress the display of content tree panes, in-line comments, or other electronic content that would otherwise be displayed in an asynchronous or non-paginated view mode. This allows for a more focused and effective presentation of the core information in the content and allows the presenter to use the content to provide a narrative or more uniform delivery of the content. As described herein, while the display of some content may be suppressed in a particular view mode, the content is preserved with respect to the presentation document and may be revealed again when the viewing mode of the content is changed or reverted.

Returning to FIG. 4G, the GUI 400 may provide a selectable element 448 to initiate the toggling view mode. In response to a request to display the content of the presentation document 440 in the toggling view mode (e.g., user selection of the element 448), the presentation document 440 may be displayed in the toggling view mode, as illustrated in FIGS. 4H-4I. As described herein, in the content toggling view mode, the content of the presentation document 440 is displayed in a full-screen pane 450 configured to provide toggle-based navigation. In the toggle-based navigation, a user input (e.g., a key input, a mouse click, a tap, a swipe, etc.) causes an automatic advance of the content of the presentation document 440 to another presentation segment within the presentation document. For example, FIG. 4H shows the entirety of the first presentation segment 438-1 prominently displayed (e.g., visually distinguished from the other presentation segments). As shown in FIG. 4I, in response to a user input, the display is advanced to the second presentation segment 438-2, in which the second presentation segment 438-2 is visually distinguished from the other presentation segments.

FIGS. 4H-4I illustrate one example technique for distinctively displaying the different presentation segments in the toggling view mode. In particular, the prominent presentation segment (e.g., the presentation segment that has focus) is visually distinguished from the other presentation segments in a manner that makes the prominent presentation segment more visible and/or pronounced relative to the other presentation segments (which remain visible in a less prominent fashion). For example, the prominent presentation segment may be shown with a greater darkness or opacity than the other visible presentation segments. As another example, as shown in FIGS. 4H-4I, the prominent presentation segment may be shown larger than the other visible presentation segments. In this example, when the focus changes to another presentation segment, the new prominent presentation segment may be shown in the larger or increased size, while the size of the previously prominent presentation segment is reduced. Other techniques for visually distinguishing between the presentation segments are also contemplated.

In examples where the presentation document is formatted as a series of discrete slides, the toggling view mode may display each slide independently, and advance between slides in response to user input. In some cases, the user may select whether the presentation document is displayed in the toggling view mode or the slide mode. More particularly, since the presentation document is formatted as separately identifiable and/or addressed presentation segments, the document rendering service 210 of the document platform 206 may be configured to render the presentation document in various modes and/or manners (including, for example, a non-paginated view mode, a toggling view mode, and a slide mode).

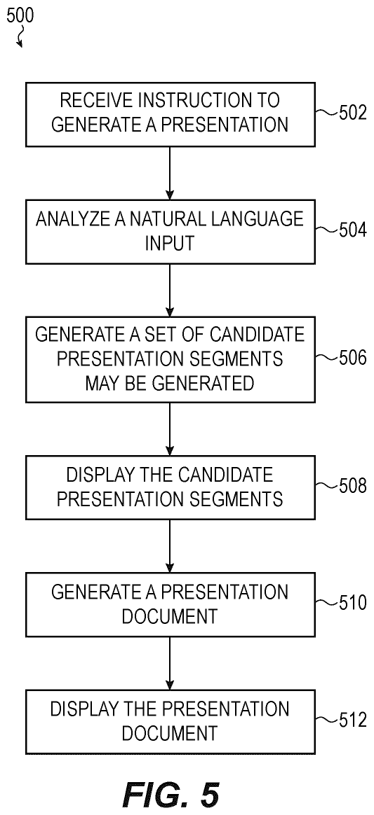

FIG. 5 depicts an example process 500 for generating a presentation from a user-generated document. The process 500 (e.g., a computer-implemented method) may be performed by a presentation service, such as the presentation service 208, in conjunction with a generative service and/or any other platforms, systems, or services described herein.

At operation 502, an instruction to generate a presentation from a selected user-generated document may be received. The instruction may include an identifier of the user-generated document and a natural language input, as described herein.

At operation 504, the natural language input may be analyzed to determine a user intent parameter for the presentation. The user intent parameter may specify, for example, a length of the presentation, an intended audience for the presentation, a complexity of the presentation, a topic or subject of the presentation, or any other information that may guide or define the presentation that is ultimately generated.

At operation 506, a set of candidate presentation segments may be generated. Generating the presentation segments may include extracting user-generated content from the user-generated document, and generating a presentation generation prompt that includes predetermined query prompt text, the extracted user-generated content from the user-generated document, and the user intent parameter for the presentation. In some cases, the presentation generation prompt also includes a user-selected presentation parameter, a user-generated content sample, an instruction to generate a respective presentation segment for each respective content heading, and/or at least a portion of the natural language input. The presentation generation prompt may be provided to a generative output engine, and a generative response may be received from the generative output engine. The set of candidate presentation segments may be generated using content in the generative response.

At operation 508, the candidate presentation segments are displayed in a presentation preview window of a graphical user interface. As described herein, a user may modify the presentation segments, change an order of the presentation segments, or otherwise edit the presentation segments in the presentation preview window.

At operation 510, a presentation document is generated, in which the presentation document includes the set of candidate presentation segments (as optionally modified by the user in the presentation preview window). The presentation document may also be stored in association with a document platform, and in a hierarchical relationship to the user-generated document that was used to generate the presentation document.

At operation 512, the presentation document is displayed. The presentation document may be displayed in a non-paginated view mode, a toggling view mode, and/or a slide view mode, as described herein.

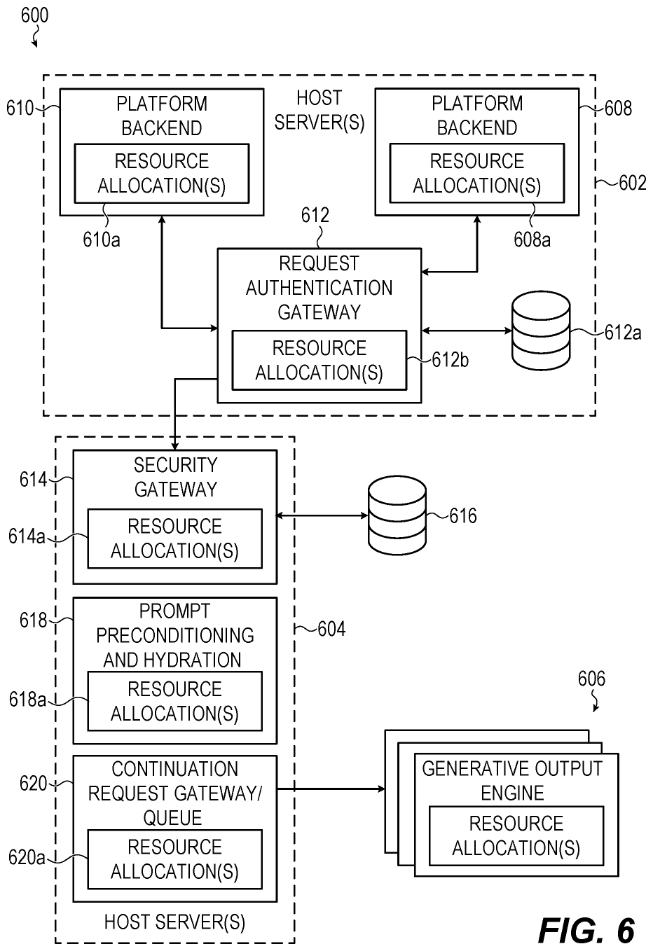

FIG. 6 depicts a system diagram and network/communication architectures that may support a system as described herein. The system 600 includes a first set of host servers 602 associated with one or more software platform backends. These software platform backends can be communicably coupled to a second set of host servers 604 purpose configured to process requests and responses to and from one or more generative output engines 606.

Specifically, the first set of host servers 602 (which, as described above can include processors, memory, storage, network communications, and any other suitable physical hardware cooperating to instantiate software) can allocate certain resources to instantiate a first and second platform backend, such as a first platform backend 608 and a second platform backend 610. Each of these respective backends can be instantiated by cooperation of processing and memory resources associated to each respective backend. As illustrated, such dedicated resources are identified as the resource allocations 608a and the resource allocations 610a.

Each of these platform backends can be communicably coupled to an authentication gateway 612 configured to verify, by querying a permissions table, directory service, or other authentication system (represented by the database 612a) whether a particular request for generative output from a particular user is authorized. Specifically, the second platform backend 610 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 612 can deny the request for insufficient permissions. This example is merely one and is not intended to be limiting; many possible authorization and authentication operations can be performed by the authentication gateway 612. The authentication gateway 612 may be supported by physical hardware resources, such as a processor and memory, represented by the resource allocations 612b.

Once the authentication gateway 612 determines that a request from a user of either platform is authorized to access data or resources implicated in service that request, the request may be passed to a security gateway 614, which may be a software instance supported by physical hardware identified in FIG. 6 as the resource allocations 614a. The security gateway 614 may be configured to determine whether the request itself conforms to one or more policies or rules (data and/or executable representations of which may be stored in a database 616) established by the organization. For example, the organization may prohibit executing prompts for offensive content, value-incompatible content, personally identifying information, health information, trade secret information, unreleased product information, secret project information, and the like. In other cases, a request may be denied by the security gateway 614 if the prompt requests are beyond a threshold quantity of data.

Once a particular user-initiated prompt has been sufficiently authorized and cleared against organization-specific generative output rules, the request/prompt can be passed to a preconditioning and hydration service 618 configured to populate request-contextualizing data (e.g., user ID, document ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 618 can be a software instance supported by physical hardware represented by the resource allocations 618a. In some implementations, the hydration service 618 may also be used to rehydrate personally identifiable information (PII) or other potentially sensitive data that has been extracted from a request or data exchange in the system.

Once a prompt has been modified, replaced, or hydrated by the preconditioning and hydration service 618, it may be passed to an output gateway 620 (also referred to as a continuation gateway or an output queue). The output gateway 620 may be responsible for enqueuing and/or ordering different requests from different users or different software platforms based on priority, time order, or other metrics. The output gateway 620 can also serve to meter requests to the generative output engines 606.

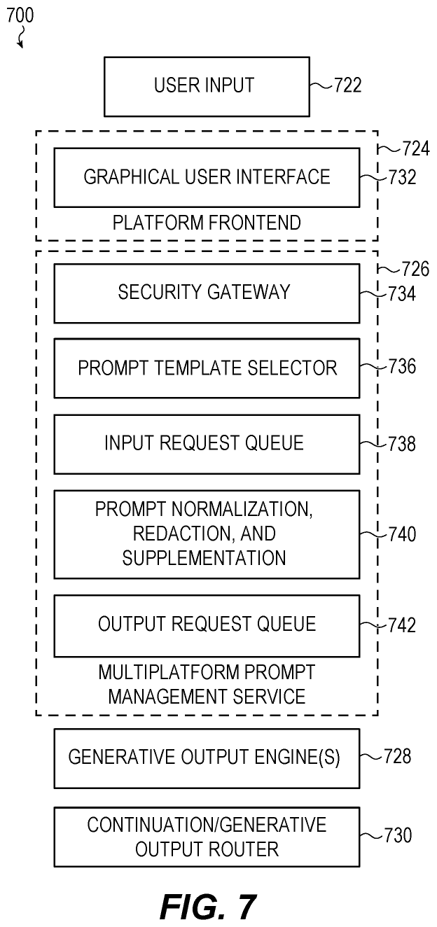

FIG. 7 depicts a functional system diagram of the system 700. In particular, the system 700 is configured to operate as a multiplatform prompt management service supporting and ordering requests from multiple users across multiple platforms, and/or from multiple services. In particular, a user input 722 may be received at a platform frontend 724. The platform frontend 724 passes the input to a prompt management service 726 that formalizes a prompt suitable for input to a generative output engine 728, which in turn can provide its output to an output router 760 that may direct generative output to a suitable destination. For example, the output router 760 may execute API requests generated by the generative output engine 728, may submit text responses back to the platform frontend 724, may wrap a text output of the generative output engine 728 in an API request to update a backend of the platform associated with the platform frontend 724, or may perform other operations.

Specifically, the user input 722 (which may be an engagement with a button, typed text input, spoken input, chat box input, and the like) can be provided to a GUI 732 of the platform frontend 724. The GUI 732 can be communicably coupled (optionally via another service, such as a presentation service) to a security gateway 734 of the prompt management service 726 that may be configured to determine whether the user input 722 is authorized to execute and/or complies with organization-specific rules.

The security gateway 734 may provide output to a prompt selector 736 which can be configured to select a prompt template from a database of preconfigured prompts, templatized prompts, or engineered templatized prompts. Once the raw user input is transformed into a string prompt, the prompt may be provided as input to a request queue 738 that orders different user request for input from the generative output engine 728. Output of the request queue 738 can be provided as input to a prompt hydrator 740 configured to populate template fields, add context identifiers, supplement the prompt, and perform other normalization operations described herein. In other cases, the prompt hydrator 740 can be configured to segment a single prompt into multiple discrete requests, which may be interdependent or may be independent.

Thereafter, the modified prompt(s) can be provided as input to an output queue at 742 that may serve to meter inputs provided to the generative output engine 728.

These foregoing embodiments depicted in FIGS. 6-7 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

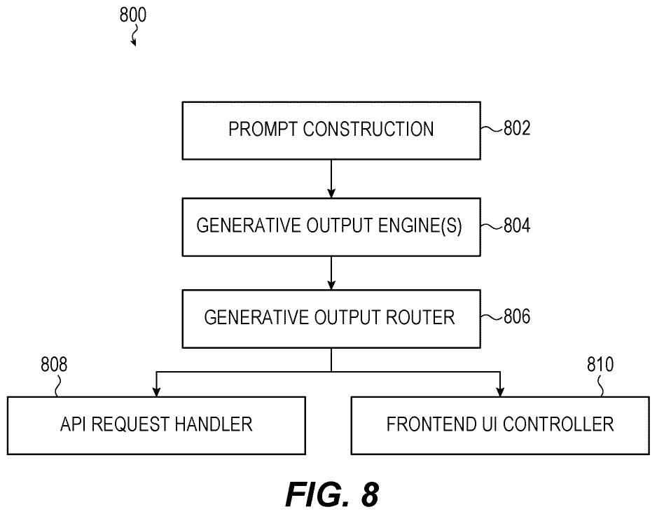

Although many constructions are possible, FIG. 8 depicts a simplified system diagram and data processing pipeline as described herein. The system 800 receives user input, and constructs a prompt therefrom at operation 802. After constructing a suitable prompt, and populating template fields, selecting appropriate instructions and examples for an LLM to continue, the modified constructed prompt is provided as input to a generative output engine 804. A continuation from the generative output engine 804 is provided as input to a router 806 configured to classify the output of the generative output engine 804 as being directed to one or more destinations. For example, the router 806 may determine that a particular generative output is an API request that should be executed against a particular API (e.g., such as an API of a system or platform as described herein). In this example, the router 806 may direct the output to an API request handler 808. In another example, the router 806 may determine that an automation execution including a generative output may be suitably directed to a GUI/frontend.

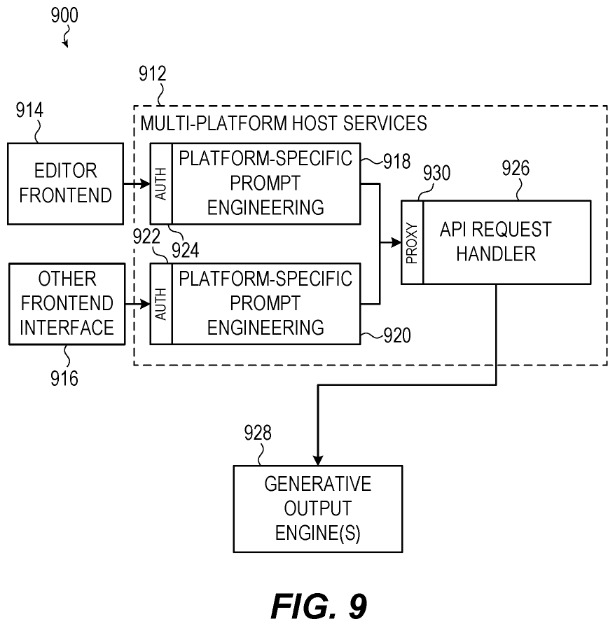

Another example architecture is shown in FIG. 9, illustrating a system providing prompt management, and in particular multiplatform prompt management as a service. The system 900 is instantiated over cloud resources, which may be provisioned from a pool of resources in one or more locations (e.g., datacenters). In the illustrated embodiment, the provisioned resources are identified as the multi-platform host services 912.

The multi-platform host services 912 can receive input from one or more users in a variety of ways. For example, some users may provide input via an editor region 914 of a frontend, such as described above. Other users may provide input by engaging with other user interface elements 916 unrelated to common or shared features across multiple platforms. Specifically, the second user may provide input to the multi-platform host services 912 by engaging with one or more platform-specific user interface elements. In yet further examples, one or more frontends or backends can be configured to automatically generate one or more prompts for continuation by generative output engines as described herein. More generally, in many cases, user input may not be required, and prompts may be requested and/or engineered automatically.

The multi-platform host services 912 can include multiple software instances or microservices each configured to receive user inputs and/or proposed prompts and configured to provide, as output, an engineered prompt. In many cases, these instances—shown in the figure as the platform-specific prompt engineering services 918, 920—can be configured to wrap proposed prompts within engineered prompts retrieved from a database such as described above.

In many cases, the platform-specific prompt engineering services 918, 920 can be each configured to authenticate requests received from various sources. In other cases, requests from editor regions or other user interface elements of particular frontends can be first received by one or more authenticator instances, such as the authentication instances 922, 924. In other cases, a single centralized authentication service can provide authentication as a service to each request before it is forwarded to the platform-specific prompt engineering services 918, 920.

Once a prompt has been engineered/supplemented by one of the platform-specific prompt engineering services 918, 920, it may be passed to a request queue/API request handler 926 configured to generate an API request directed to a generative output engine 928 including appropriate API tokens and the engineered prompt as a portion of the body of the API request. In some cases, a service proxy 930 can interpose the platform-specific prompt engineering services 918, 920 and the request queue/API request handler 926, so as to further modify or validate prompts prior to wrapping those prompts in an API call to the generative output engine 928 by the request queue/API request handler 926 although this is not required of all embodiments.

These foregoing embodiments depicted in FIGS. 6-9 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

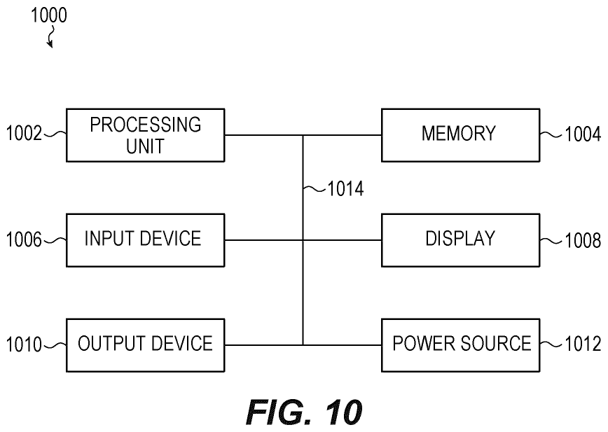

FIG. 10 shows a sample electrical block diagram of an electronic device 1000 that may perform the operations described herein. The electronic device 1000 may in some cases take the form of any of the electronic devices described with reference to FIGS. 1-9, including client devices, and/or servers or other computing devices associated with the system 100. The electronic device 1000 can include one or more of a processing unit 1002, a memory 1004 or storage device, input devices 1006, a display 1008, output devices 1010, and a power source 1012. In some cases, various implementations of the electronic device 1000 may lack some or all of these components and/or include additional or alternative components.

The processing unit 1002 can control some or all of the operations of the electronic device 1000. The processing unit 1002 can communicate, either directly or indirectly, with some or all of the components of the electronic device 1000. For example, a system bus or other communication mechanism 1014 can provide communication between the processing unit 1002, the power source 1012, the memory 1004, the input device(s) 1006, and the output device(s) 1010. The processing unit 1002 may be operably coupled to the computer-readable memory 1004, which stores computer-readable instructions. The computer-readable instructions, when executed by the processing unit 1002 may cause the device or system to perform operations described herein with respect to the example embodiments and processes.

The processing unit 1002 can be implemented as any electronic device capable of processing, receiving, or transmitting data or instructions. For example, the processing unit 1002 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1000 can be controlled by multiple processing units. For example, select components of the electronic device 1000 (e.g., an input device 1006) may be controlled by a first processing unit and other components of the electronic device 1000 (e.g., the display 1008) may be controlled by a second processing unit, where the first and second processing units may or may not be in communication with each other.

The power source 1012 can be implemented with any device capable of providing energy to the electronic device 1000. For example, the power source 1012 may be one or more batteries or rechargeable batteries. Additionally, or alternatively, the power source 1012 can be a power connector or power cord that connects the electronic device 1000 to another power source, such as a wall outlet.

The memory 1004 can store electronic data that can be used by the electronic device 1000. For example, the memory 1004 can store electronic data or content such as, for example, audio and video files, documents and applications, device settings and user preferences, timing signals, control signals, and data structures or databases. The memory 1004 can be configured as any type of memory. By way of example only, the memory 1004 can be implemented as random access memory, read-only memory, flash memory, removable memory, other types of storage elements, or combinations of such devices.

In various embodiments, the display 1008 provides a graphical output, for example associated with an operating system, user interface, and/or applications of the electronic device 1000 (e.g., a chat user interface, an issue-tracking user interface, an issue-discovery user interface, etc.). In one embodiment, the display 1008 includes one or more sensors and is configured as a touch-sensitive (e.g., single-touch, multi-touch) and/or force-sensitive display to receive inputs from a user. For example, the display 1008 may be integrated with a touch sensor (e.g., a capacitive touch sensor) and/or a force sensor to provide a touch- and/or force-sensitive display. The display 1008 is operably coupled to the processing unit 1002 of the electronic device 1000.

The display 1008 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1008 is positioned beneath and viewable through a cover that forms at least a portion of an enclosure of the electronic device 1000.

In various embodiments, the input devices 1006 may include any suitable components for detecting inputs. Examples of input devices 1006 includes light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1006 may be configured to detect one or more particular types of input and provide a signal (e.g., an input signal) corresponding to the detected input. The signal may be provided, for example, to the processing unit 1002.

As discussed above, in some cases, the input device(s) 1006 includes a touch sensor (e.g., a capacitive touch sensor) integrated with the display 1008 to provide a touch-sensitive display. Similarly, in some cases, the input device(s) 1006 include a force sensor (e.g., a capacitive force sensor) integrated with the display 1008 to provide a force-sensitive display.

The output devices 1010 may include any suitable components for providing outputs. Examples of output devices 1010 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 1010 may be configured to receive one or more signals (e.g., an output signal provided by the processing unit 1002) and provide an output corresponding to the signal.

In some cases, input devices 1006 and output devices 1010 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1002 may be operably coupled to the input devices 1006 and the output devices 1010. The processing unit 1002 may be adapted to exchange signals with the input devices 1006 and the output devices 1010. For example, the processing unit 1002 may receive an input signal from an input device 1006 that corresponds to an input detected by the input device 1006. The processing unit 1002 may interpret the received input signal to determine whether to provide and/or change one or more outputs in response to the input signal. The processing unit 1002 may then send an output signal to one or more of the output devices 1010, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method of generating a presentation from a user-generated document, the method comprising:
causing display of a graphical user interface of a client application operating on a client device, the graphical user interface including:
a content pane configured to display a user-generated document in a non-paginated view mode providing continuous scrolling of the user-generated document across content sections; and
a content tree displayed in a content tree pane, the content tree comprising a tree of selectable elements corresponding to a set of documents having a hierarchical relationship to the user-generated document;
receiving, from the graphical user interface, an instruction to generate a presentation from the user-generated document, the instruction including an identifier of the user-generated document and a natural language input;
extracting user-generated content from the user-generated document;
analyzing the natural language input to determine a user intent parameter for the presentation;
generating a set of candidate presentation segments, comprising:
generating a presentation generation prompt comprising:
predetermined query prompt text;
the extracted user-generated content from the user-generated document; and
the user intent parameter for the presentation;
providing the presentation generation prompt to a generative output engine; and
receiving a generative response from the generative output engine;
based on the generative response, generating a set of candidate presentation segments;
causing the set of candidate presentation segments to be displayed in a presentation preview window of the graphical user interface;
receiving, in the presentation preview window, a first user input modifying a candidate presentation segment of the set of candidate presentation segments, thereby producing a modified set of candidate presentation segments;
in response to a second user input accepting the modified set of candidate presentation segments, generating a presentation document including the modified set of candidate presentation segments;
storing the presentation document in association with a document platform and displaying an identifier of the presentation document in position in the content tree reflecting a hierarchical relationship between the presentation document and the user-generated document;
causing display of content of the presentation document in the graphical user interface in the non-paginated view mode; and
in response to a request to display the content of the presentation document in a content toggling view mode, causing display of the content of the presentation document in the content toggling view mode, the content toggling view mode comprising the content of the presentation document displayed in a full-screen pane configured to provide toggle-based navigation in which a third user input causes an automatic advance of the content of the presentation document to a respective presentation segment identified within the content of the presentation document.

2. The computer-implemented method of claim 1, wherein:
the method further comprises:
causing display of a presentation generation selection window in the graphical user interface, the presentation generation selection window comprising:
a text input field for receiving the natural language input; and
a presentation parameter selection element for receiving a user selection of a presentation parameter;
the instruction to generate the presentation includes the user-selected presentation parameter; and
the presentation generation prompt further comprises the user-selected presentation parameter.

3. The computer-implemented method of claim 2, further comprising:
generating a constraint for the presentation parameter selection element based at least in part on the natural language input; and
displaying the constraint for the presentation parameter selection element in the presentation generation selection window.

4. The computer-implemented method of claim 1, wherein:
the method further comprises extracting a user content sample from at least one other document generated by a user; and
the presentation generation prompt further comprises the user content sample.

5. The computer-implemented method of claim 1, wherein:
generating the presentation generation prompt comprises:
identifying, in the user-generated document, a data structure referencing a separate document;
generating a unique identifier for the data structure; and
including the unique identifier in the presentation generation prompt; and
generating the set of candidate presentation segments comprises:
identifying the unique identifier in the generative response; and
replacing the unique identifier with the data structure.

6. The computer-implemented method of claim 1, wherein analyzing the natural language input to determine the user intent parameter for the presentation comprises selecting the user intent parameter from a set of predetermined user intent parameters.

7. The computer-implemented method of claim 1, further comprising while content of the presentation document is displayed in the graphical user interface in the non-paginated view mode, receiving a change to the content of the presentation document.

8. The computer-implemented method of claim 1, wherein:
the user-generated document includes a plurality of content headings; and
the presentation generation prompt includes an instruction to generate a respective presentation segment for each respective content heading.

9. The computer-implemented method of claim 1, further comprising:
generating a set of presentation slides, the generating comprising generating a respective presentation slide for each respective presentation segment of the presentation document.

10. A computer-implemented method of generating a presentation from a user-generated document, the method comprising:
causing display of a graphical user interface of a client application operating on a client device, the graphical user interface including a content pane configured to display a user-generated document;
receiving, from the graphical user interface, a selection of a user-generated document from which to generate a presentation document;
analyzing the user-generated document to identify a content property of the user-generated document;
generating a constraint for a presentation parameter based at least in part on the content property;
causing display of a presentation generation selection window in the graphical user interface, the presentation generation selection window comprising:
a text input field for receiving a natural language input; and
a presentation parameter selection element for receiving a user selection of the presentation parameter;
extracting user-generated content from the user-generated document;
generating a set of candidate presentation segments for the presentation document, comprising:
generating a presentation generation prompt comprising:
predetermined query prompt text;
the extracted user-generated content;
at least a portion of the natural language input; and
the user selection of the presentation parameter;
providing the presentation generation prompt to a generative output engine; and
receiving a generative response from the generative output engine;
based on the generative response, generating a set of candidate presentation segments;
causing the set of candidate presentation segments to be displayed in a presentation preview window of the graphical user interface;
in response to a first user input accepting the set of candidate presentation segments, generating a presentation document including the set of candidate presentation segments;
storing the presentation document in association with a document platform; and
causing display of content of the presentation document in the graphical user interface in a content toggling view mode, the content toggling view mode comprising the content of the presentation document displayed in a full-screen pane configured to provide toggle-based navigation in which a second user input causes an automatic advance of the content of the presentation document to a respective presentation segment identified within the content of the presentation document.

11. The computer-implemented method of claim 10, wherein:
the method further comprises receiving, in the presentation preview window, a third user input modifying a candidate presentation segment of the set of candidate presentation segments, thereby producing a modified set of candidate presentation segments; and
generating the presentation document includes generating the presentation document to include the modified set of candidate presentation segments.

12. The computer-implemented method of claim 10, further comprising, prior to causing display of content of the presentation document in the content toggling view mode, causing display of content of the presentation document in a non-paginated view mode providing continuous scrolling of the presentation document.

13. The computer-implemented method of claim 10, wherein:
the method further comprises analyzing the natural language input to determine a user intent parameter for the presentation; and
the presentation generation prompt further comprises the user intent parameter.

14. The computer-implemented method of claim 10, wherein:
the presentation parameter is a number of presentation segments to include in the presentation document; and
the constraint for the presentation parameter is based on a length of the user-generated document.

15. The computer-implemented method of claim 14, wherein the constraint includes a maximum number of presentation segments and a minimum number of presentation segments.

16. The computer-implemented method of claim 15, wherein the presentation parameter selection element comprises a slider element that allows a selection of the presentation parameter between the maximum number of presentation segments and the minimum number of presentation segments.

17. A system comprising:
one or more processing units;
computer readable memory storing computer readable instructions that when executed by the one or more processing units cause the system to:
cause display of a graphical user interface of a client application operating on a client device, the graphical user interface including a content pane configured to display a user-generated document;
receive, from the graphical user interface, a selection of a user-generated document from which to generate a presentation document;
extract user-generated content from the user-generated document;
identify, in the user-generated content, a data structure referencing a separate document;
generate a unique identifier for the data structure;
incorporate the unique identifier into the extracted user-generated content;
generate a set of candidate presentation segments for the presentation document, comprising:
generating a presentation generation prompt comprising:
predetermined query prompt text; and
the extracted user-generated content;
providing the presentation generation prompt to a generative output engine; and
receiving a generative response from the generative output engine;
based on the generative response, generate a set of candidate presentation segments, including:
identifying the unique identifier in the generative response; and
replacing the unique identifier with the data structure;
cause the set of candidate presentation segments to be displayed in a presentation preview window of the graphical user interface;
in response to a first user input accepting the set of candidate presentation segments, generate a presentation document including the set of candidate presentation segments;
store the presentation document in association with a document platform; and
cause display of content of the presentation document in the graphical user interface in a content toggling view mode, the content toggling view mode comprising the content of the presentation document displayed in a full-screen pane configured to provide toggle-based navigation in which a second user input causes an automatic advance of the content of the presentation document to a respective presentation segment identified within the content of the presentation document.

18. The system of claim 17, wherein, when displayed in the content toggling view mode, the data structure is replaced by content extracted from a source referenced by the data structure.

19. The system of claim 17, wherein:
the computer readable instructions further cause the system to receive, in the presentation preview window, a third user input modifying an order of the set of candidate presentation segments; and
generating the presentation document includes generating the presentation document according to the modified order of the set of candidate presentation segments.

20. The system of claim 19, wherein:
the computer readable instructions further cause the system to:
prior to causing display of content of the presentation document in the content toggling view mode, cause display of content of the presentation document in a non-paginated view mode; and
receive a fourth user input modifying at least one candidate presentation segment of the set of candidate presentation segments; and
generating the presentation document includes generating the presentation document to include the modified at least one candidate presentation segment.
